(19) United States
(12) Patent Application Publication
(10) Pub. No.: US 2026/0174212 A1
(43) Pub. Date: Jun. 25, 2026

(54) NAIL CUTTING APPARATUS

(71) Applicant: Jotero LLC, Oklahoma City, OK (US)

(72) Inventors: Trevor Ryan Fogleman, Oklahoma City, OK (US); Joel Douglas Quarnstrom, Oklahoma City, OK (US)

(21) Appl. No.: 19/421,876

(22) Filed: Dec. 16, 2025

Related U.S. Application Data
(60) Provisional application No. 63/737,781, filed on Dec. 22, 2024.

(51) Int. Cl. A45D 29/06; B25J 9/00; B25J 9/16; B25J 11/00; B25J 13/08

(52) U.S. Cl. CPC A45D 29/06; B25J 9/0084; B25J 9/1638; B25J 9/1664; B25J 11/0065; B25J 13/085

(57) ABSTRACT

A system for nail shaping may include a placement platform configured to receive an extremity of a user, a frame, a robotic arm secured to the frame, an end effector operatively connected to the robotic arm, a sensor, and a control system. The end effector may include a shaping tool operatively connected to a motor and a force sensing system configured to measure a force applied by the shaping tool. The control system may be configured to receive, from the sensor, data associated with a portion of the extremity and generate a three-dimensional (3D) scan of the portion based on the data. The control system may be configured to receive a measurement of the force applied by the shaping tool, generate a toolpath for the end effector based on the 3D scan and the received measurement, and operate the robotic arm and the end effector based on the generated toolpath.

### PRIORITY

This patent application claims priority to U.S. Provisional Application No. 63/737,781, filed Dec. 22, 2024, which is hereby incorporated by reference in its entirety.

### TECHNICAL FIELD

The present disclosure relates generally, but is not limited, to nail shaping (e.g., cutting). More specifically, the present disclosure relates to methods and systems for controlling robotic movement to shape (e.g., cut, grind, trim, buff, etc.) or otherwise modify one or more nails of a user.

### BACKGROUND

Fingernails and toenails may be periodically shaped for health, hygienic, and/or aesthetic purposes by an individual, a nail artist (e.g., manicurist, pedicurist), or a medical doctor such as a podiatrist. Tools for shaping nails include nail clippers (e.g., nail nippers in the medical field), an emery board, or a rotating grinding tool. It is challenging, particularly for individuals with mobility-limiting or health conditions (e.g., elderly, diabetic, etc.) to perform this process safely and satisfactorily. It is additionally time-consuming and costly for any provider of nail-shaping services (e.g., a manicurist or podiatrist) to perform the process. Thus, there is a need for improved systems and methods for nail shaping.

### SUMMARY

According to embodiments of the present disclosure, the above-described disadvantages associated with existing solutions may be reduced or eliminated.

Embodiments of systems, methods, and non-transitory computer readable medium for nail shaping are disclosed herein. According to a first aspect of the disclosure, a system for nail shaping may include: a placement platform, the placement platform configured to receive at least one extremity comprising digits of a user; a frame; a robotic arm secured to the frame; a motor; and an end effector operatively connected to a distal end of the robotic arm relative to the frame, the end effector comprising: a shaping tool operatively connected to the motor; and a force sensing system configured to measure a force applied by the shaping tool. The system may further include: a sensor positioned to face the at least one extremity; and a control system comprising one or more processors configured to: receive, from the sensor, data associated with a portion of the at least one extremity; generate a three-dimensional (3D) scan of the portion of the at least one extremity based at least in part on data received from the sensor; receive, from the force sensing system, a measurement of the force applied by the shaping tool; generate a toolpath for the end effector based at least in part on the 3D scan and the measurement received from the force sensing system; and operate the robotic arm and the end effector based at least in part on the generated toolpath.

According to a second aspect of the disclosure, a method for nail shaping using a robotic arm and an end effector may include: receiving, from a sensor, data associated with a portion of an extremity comprising digits of a user; generating a 3D scan of the portion of the extremity based at least in part on the data received from the sensor; receiving, from a force sensing system of the end effector, a measurement of a force applied by a shaping tool of the end effector to the extremity; generating a toolpath for the end effector based at least in part on the 3D scan and the measurement received from the force sensing system; and operating the robotic arm and the end effector based at least in part on the generated toolpath.

According to a third aspect of the disclosure, a non-transitory computer-readable medium may store code for nail shaping using a robotic arm and an end effector, the code comprising instructions executable by one or more processors to: receive, from a sensor, data associated with a portion of an extremity of a user; generate a 3D scan of the portion of the extremity based at least in part on the data received from the sensor; receive, from a force sensing system of the end effector, a measurement of a force applied by a shaping tool of the end effector to the extremity; generate a toolpath for the end effector based at least in part on the 3D scan and the measurement received from the force sensing system; and operate the robotic arm and the end effector based at least in part on the generated toolpath.

Certain embodiments of the present disclosure may provide one or more technical advantages. As one example, the systems and techniques described herein support more accurate and quicker nail shaping across a wide variety of physical morphologies and health conditions. For example, generating toolpaths that govern the movement and operation of end effectors using 3D scans and other information acquired by the system (e.g., force measurements, temperature measurements, contact-detection, and current measurements, among others described herein) support highly precise and accurate nail shaping. Additionally, concurrent nail shaping of multiple nails on one or more extremities speeds up overall treatment and nail shaping processes. As another example, the systems and techniques described herein support safe nail shaping. For example, safety mechanisms described herein may ensure that the user remains unharmed during the nail shaping process. As another example, the systems and techniques described herein support scanning and nail shaping for a range of orientations that the extremity may be in, such as with the digits pointing forward, upward, to the side, and so on. As another example, the systems and techniques described herein support nail shaping while maintaining a clean environment, such as by including a vacuum system configured to suck dust away from the extremity during the nail shaping process. Moreover, while specific advantages have been enumerated above, various embodiments may include all, some, or none of the enumerated advantages.

### BRIEF DESCRIPTION OF DRAWINGS

To facilitate a more complete understanding of the disclosed embodiments and their features and advantages, reference is now made to the appended drawings. The drawings should not be construed as limiting the present disclosure but are intended only to illustrate different aspects and embodiments of the disclosure.

FIGS. 1A, 1B, and 1C depict an example embodiment of a system for nail shaping in accordance with one or more aspects of the present disclosure.

FIGS. 2A, 2B, 2C, and 2D depict aspects of a system for nail shaping in accordance with one or more aspects of the present disclosure.

FIG. 3 depicts an example embodiment of an operation sequence for operating a system for nail shaping in accordance with one or more aspects of the present disclosure.

FIGS. 4A, 4B, 4C, and 4D depict aspects of a system for nail shaping in accordance with one or more aspects of the present disclosure.

FIGS. 5A, 5B, 5C, and 5D depict aspects of a system for nail shaping in accordance with one or more aspects of the present disclosure.

FIGS. 6A, 6B, 6C, 6D, 6E, and 6F depict aspects of an example embodiment of an end effector in accordance with one or more aspects of the present disclosure.

FIG. 7 depicts a block diagram of a system for nail shaping in accordance with one or more aspects of the present disclosure.

FIGS. 8A, 8B, 8C, 8D, 8E, and 9 depict an example embodiment of a system for nail shaping in accordance with one or more aspects of the present disclosure.

FIGS. 10A and 10B depict aspects of an example embodiment of an end effector in accordance with one or more aspects of the present disclosure.

FIGS. 11 and 12 depict aspects of a system for nail shaping in accordance with one or more aspects of the present disclosure.

FIGS. 13A, 13B, and 13C depict aspects of a system for nail shaping in accordance with one or more aspects of the present disclosure.

FIGS. 14A and 14B depict a system for nail shaping in accordance with one or more aspects of the present disclosure.

FIGS. 15 and 16 depict flowcharts illustrating methods in accordance with one or more aspects of the present disclosure.

### DETAILED DESCRIPTION

In some embodiments, a nail shaping system (e.g., an automatic nail modification system) and method are disclosed. In accordance with example embodiments disclosed herein, the system and method may automate and improve upon the nail shaping (e.g., nail modification) process to make it quick and safe for use in medical, business, or home settings by users with a wide variety of physical morphologies and health conditions. The system and method may automate the toenail shaping process, the fingernail shaping process, or both. The system and method support quicker and more accurate nail shaping (e.g., relative to manual nail shaping) and safe nail shaping in a medical environment for procedures like nail debridement or nail trimming, in a business environment like nail salons, spas, retirement or assisted living facilities, hotels or resorts, or in a home environment for children and adult routine nail hygiene, among other environments and uses.

According to one advantageous aspect of the present disclosure, users of the system may have a wide range of physical morphologies and still have the nail shaping process performed on them automatically by the system and method. These morphologies are inclusive of nail (e.g., toenail, fingernail) and digit (e.g., toe, finger) size, shape, age, and presence of health conditions like hammer toes or mycotic infections. In some embodiments, the system may be fully automated to perform the nail shaping process after selection (e.g., and confirmation) of one or more desired sub-processes and nail features by the user or a responsible party (e.g., an operator of the system, such as a podiatrist, a hand specialist, a nail artist, a home user). As described in more detail herein, these selections may include selecting (e.g., specifying) which nails to perform the process on, which nails to ignore, which nails to perform specific shaping movements on, desired nail shape (e.g., square ends, rounded ends, customization to an irregular shape), desired nail thickness, desired nail length, and desired nail smoothness, among others.

In some example embodiments, the process selection may include selecting one or more of a maximum measured heat threshold, a maximum nail shaping tool rotation speed threshold, or a minimum level of deviation in the user's nail position or orientation during the process. If one or more of these limits are violated, the system may trigger a full-stop and readjustment of the end effectors to begin the process again. In some example embodiments, the system may store and implement these limits without user selection. In some example embodiments, sub-process and feature selection may be grouped together into general user selections that apply multiple selections at once. In some example embodiments, a user or operator may make the selections using a digital application located on an associated (e.g., external) device accessible to the user or operator. In some embodiments, selections are made on a digital screen connected to or near the system, or through a series of switches and/or dials connected to the system. In some embodiments, the system makes all decisions regarding the nail shaping sub-processes (e.g., and limits) to perform the entire nail-shaping process automatically after confirmation to start the process.

In the following description, for the purposes of explanation, numerous specific details are set forth to provide a thorough understanding of examples in the present disclosure. It will be apparent, however, that the examples may be practiced without these specific details. In other instances, aspects of the system for nail shaping may be depicted in block diagram form in order to avoid unnecessarily obscuring the examples.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the present disclosure. Instead, they are merely examples of apparatuses and methods consistent with aspects related to the disclosure as recited in the appended claims.

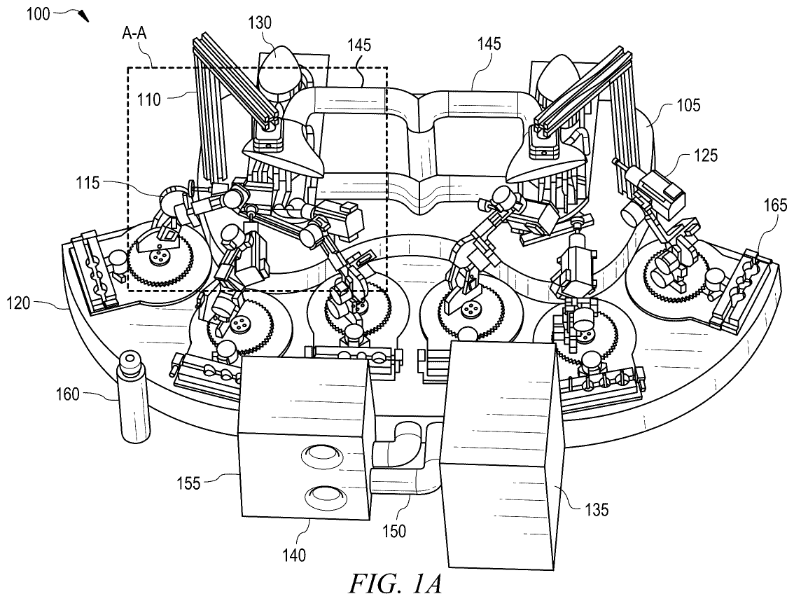

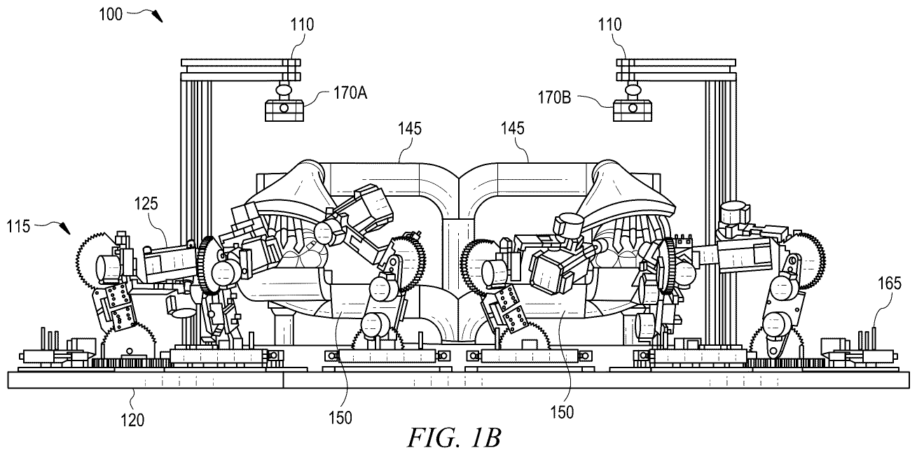

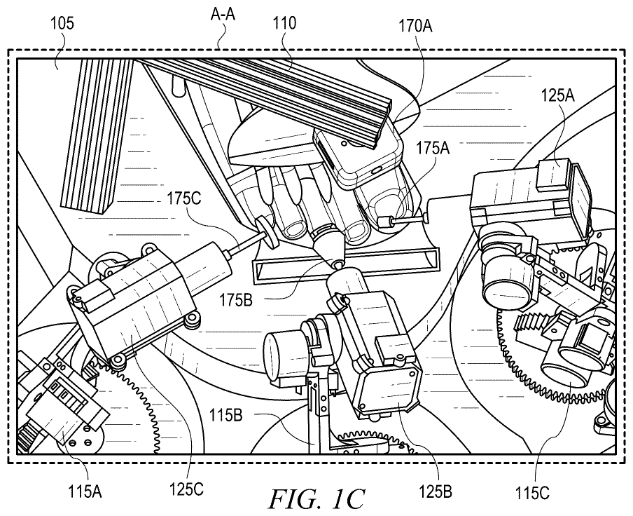

FIGS. 1A, 1B, and 1C depict an example embodiment of a system 100 for nail shaping in accordance with one or more aspects of the present disclosure. The system 100 supports automated nail shaping of one or more nails of a user. FIG. 1A depicts an upper-front perspective view of the system 100. FIG. 1B depicts a front view of the system 100 (with the electronics housing 135, vacuum system 140, duct system 150, nail dust chamber 155, and controller 160 removed for illustrative clarity). FIG. 1C depicts a close-up perspective view of the portion of the system 100 depicted along line A-A of FIG. 1A.

The system 100 may include a placement platform 105 configured to receive at least one extremity 130 of a user. For example, the placement platform 105 may be a structure of the system 100 onto which the user may place at least one extremity 130. An extremity 130 may be a portion of the user that includes one or more digits (e.g., fingers, toes), such as a foot or a hand. In the example of the system 100 of FIG. 1A, the user may place one or both feet onto the placement platform 105.

Adjacent to the placement platform 105, the system 100 may include a robotic arm platform 120 (e.g., a mechanical arm platform) on which one or more robotic arms 115 (e.g., mechanical arms) may be connected. In some example embodiments, robotic arm platform 120 may be underneath or above the placement platform 105. In some example embodiments, the robotic arm platform may be on a same plane as the placement platform 105. The robotic arm platform 120 may be connected on at least one side to a frame 110 that may extend over or around the robotic arm platform 120. In some example embodiments, the robotic arms 115 may be connected to the frame 110.

In some example embodiments, there may be a membrane or soft barrier between the placement platform 105 and the robotic arm platform 120 with one or more openings that the user can slide the extremity 130 or digits of the extremity 130 (e.g., feet, toes, hands, fingers) through. This may advantageously create an isolated space for the nail shaping process to occur that may obstruct the user's seeing or hearing the nail shaping process and prevent most nail dust particles from escaping into the surrounding air.

The system 100 may include one or more end effectors 125 operatively connected (e.g., attached, affixed) to the robotic arms 115. For example, a respective end effector 125 may be operatively connected to a distal end of a respective robotic arm 115 (e.g., distal ends of the robotic arms 115 relative to the frame 110 or robotic arm platform 120). An end effector 125 may include a shaping tool 175 used to shape a nail of the extremity 130. For instance, the example of FIG. 1C depicts a portion of the system 100 including three robotic arms 115A, 115B, 115C operatively connected to end effectors 125A, 125B, 125C, respectively. The end effectors 125A, 125B, 125C may include the shaping tools 175A, 175B, 175C, respectively. The system 100 may support independently (e.g., and concurrently) operating the robotic arms 115A, 115B, 115C and the end effectors 125A, 125B, 125C to shape respective nails of the extremity 130.

The system 100 may include one or more tool racks 165 near each of the robotic arms 115 that hold a variety of nail shaping tools 175. The nail shaping tools 175 may collectively perform one or more, and in some cases all, of the functions defined by a toolpath planning system in the nail shaping process. In some embodiments, each tool rack 165 may be assigned for use by a single robotic arm 115. In some embodiments, one or more tool racks 165 may hold the shaping tools 175 which all or a subset of the robotic arms 115 may access to perform nail shaping tool replacements (e.g., a tool rack 165 may be shared by multiple robotic arms 115). Shaping tools 175 in a tool rack 165 may include tools to clean, mark, and disinfect the nails according to the user's selection, such as rotary burrs of varying grit levels, nail filing tools, or nail trimming tools, among others. In some example embodiments, shafts of the shaping tools 175 may protrude vertically out of the tool rack 165. In some example embodiments, the nail shaping tool shafts may be completely enclosed by the tool rack 165 or protrude out from the tool rack 165 horizontally, or in some other direction.

The system 100 may support generating a 3D scan of at least a portion of an extremity 130 to facilitate the automated nail shaping. For example, a suite of one or more sensors 170 (e.g., depth cameras) may be connected to the frame 110 and positioned to face the placement platform 105 (e.g., respective extremities 130). The sensors 170 may be connected in locations that provide an optimal view of the user's nails and the end effectors 125. These sensors 170 (e.g., sensor 170A, sensor 170B in FIG. 1B) may be configured to scan a portion of the user's extremity 130 (e.g., nails, toes, fingers) to generate a three-dimensional (3D) scan of an extremity 130, such as a 3D spatial point cloud representation. In some example embodiments, the sensors 170 may be configured to scan placement platform straps, end effectors 125, robotic arms 115, or a combination thereof to generate the 3D scan (e.g., to include as part of the 3D scan of the extremity 130). In some example embodiments, one or more of the sensors 170 may be mounted on one or more gimble systems connected to the frame 110 and configured to move the sensors 170 around to change the view of the nails and generate more accurate toolpaths. In some example embodiments, a gimble system may have one or more motors to change the angle of one or more sensors 170 in one or multiple axes, and it may also translate one or more sensors 170 in one or multiple directions. In some example embodiments, one or more of the sensors 170 may be connected to end effectors 125 or robotic arms 115 or the robotic arm platform 120.

The system 100 may support alternative techniques for generating the 3D scan. For instance, in some example embodiments, the sensors 170 may be Light Detection and Ranging (LIDAR) sensors or another type of 3D scanner that supports using LIDAR, structured light scanning, time-of-flight scanning, or any other technique (e.g., point cloud generating system) for generating the 3D scan (e.g., instead of, or in addition to, a depth camera). In some example embodiments, one or more of the sensors 170 may be two-dimensional (2D) cameras. For example, the system 100 may use one or multiple 2D cameras to determine the position, orientation, and size of the extremity 130, digits, and nails (e.g., foot, toes, and toenails, hand, fingers, and fingernails); the position and orientation of a robotic arm 115 and its end effector 125 and shaping tool 175; or a combination thereof. In some example embodiments, the system 100 may use visual data captured by the 2D cameras to generate the 3D scan.

In some example embodiments, one or more temperature sensors may be connected to the frame 110 or the robotic arm platform 120 and aimed at the user's extremity 130 (e.g., nails, digits) and/or the shaping tools 175 where they contact the nails. In some example embodiments, the temperature sensors may be connected to one or more end effectors 125. In some example embodiments, the temperature sensors may be contact-based sensors such as thermocouples or thermistors. In some example embodiments, the temperature sensors may be thermal cameras.

The system 100 may use the 3D scan to generate a toolpath for an end effector 125. The toolpath may be a path that the system 100 (e.g., using the robotic arm 115) causes the end effector 125 to take as part of the nail shaping process so that the shaping tool 175 may shape the nail. In some example embodiments, the toolpath may also include other aspects of the nail shaping process, such as the shaping tool 175 to use (e.g., during a particular portion of the nail shaping process), a speed (e.g., rotational speed) of the shaping tool 175, a rotational direction of the shaping tool 175, a speed (e.g., current, power) of a motor operatively connected to the shaping tool 175. In some example embodiments, the toolpath may include a path that the system 100 causes the end effector 125 to take between a tool rack 165 and the nail (e.g., from the nail to the tool rack 165 and back, from the tool rack 165 to the nail, from a location to the tool rack 165 and then to the nail) or from one digit (e.g., nail) to another digit (e.g., nail) of the extremity 130. In some example embodiments, the system 100 may include a computer vision model in a control system (e.g., a control computer, a microcontroller) that uses the 3D scan to generate the toolpath. For example, the 3D scan (e.g., the 3D spatial point cloud from the sensor suite) may be received by the computer vision model in the control computer, which uses the 3D scan to (e.g., continuously or periodically, including at high frequencies) output a position, orientation, and specific features of one or more of the digits and nails (e.g., length, shape, thickness, nail surface geometry, digit skin surface geometry) as well as a position, orientation, and other features of the end effectors 125. This advantageously creates a detailed, understandable view of the nail shaping process for the system 100.

In some example embodiments, the computer vision model may be on a networked computer or connected to the system 100 through a wired or wireless connection. In some example embodiments, the computer vision model may implement image segmentation, 2D image registration, or 3D object registration to generate outputs. In some example embodiments, the computer vision model may be a machine vision model using neural networks, such as a U-net architecture, to create outputs. In some example embodiments, the computer vision model may be an artificial intelligence (AI) model. In some example embodiments, the neural network models may be convolutional neural networks.

The output from the computer vision model (e.g., position, orientation, and specific features of the digits and nails and/or end effectors 125) may be received by the toolpath planning system of the system 100, which may be located in the control computer, on a networked computer, or hosted on a wired or wirelessly connected system. The toolpath planning system may use this output to generate a planned (e.g., respective) toolpath for one or more of the end effectors 125 to execute simultaneously (e.g., concurrently) or sequentially and thereby perform the nail shaping process on the nails. For example, the toolpath planning system may calculate a 3D geometry of the volume of the nail to be removed. The toolpath planning system may break the material removal of that volume into one or more removal (e.g., “cutting” or “grinding”) passes of one or more of the shaping tools 175. Each pass of the shaping tool 175 may remove an identified volume of nail characterized by its 3D geometry. The toolpath planning system may calculate the 3D x-y-z position of the tip of the shaping tool 175 on the end effector 125 as well as two angles of orientation (e.g., altitude and azimuth) of the shaping tool 175 and end effector 125 at each point along the length of the removal pass. The toolpath planning system may use the three position coordinates and two angle coordinates of the tip of the shaping tool 175 to calculate the joint angles and/or joint positions of each joint of a robotic arm 115, the angle of each motor (e.g., a motor may be connected to a single joint with gearing or other power transmission, so the joint angle might be a function of the motor angle instead of the same angle), or both, over the duration of the toolpath. The toolpath planning system may check if the respective toolpaths of multiple robotic arms 115 cause any part of the robotic arms 115 to collide with any other object (e.g., except for the part of the shaping tool 175 that is supposed to be touching the nail) and adjust one or more of the toolpaths to avoid any such collisions.

A robotic arm 115 may receive the generated toolpath from the toolpath planning system via output from one or more processors (e.g., microcontrollers) connected to the control computer. In some example embodiments, a robotic arm 115 may be an articulated robot arm with at least three translational degrees of freedom and at least two rotational degrees of freedom. In some example embodiments, the robotic arm 115 may be a different type of robotic arm, such as a cartesian robotic arm, a cylindrical robotic arm, a spherical robotic arm, or a selective compliance articulated robotic arm (SCARA), among other types of robotic arms. In some example embodiments, the robotic arm 115 may be a robotic arm with five or more degrees of freedom. In some example embodiments, robotic arms 115 may be one or more cylindrical grinders connected to the robotic arm platform 120 or to the frame 110, or one or more rotating grinding mechanisms connected to the robotic arm platform 120 or frame 110, or a series of grinding, cutting, and other nail-modifying mechanisms connected to the robotic arm platform 120 or frame 110.

In some example embodiments, each robotic arm 115 and its end effector 125, with any shaping tool 175 the end effector 125 is currently holding, may execute a generated toolpath to perform the nail shaping process on one or more of the nails placed in view of the suite of sensors 170 (e.g., the 3D sensor suite). The generated toolpaths may be executed either simultaneously (e.g., concurrently) or one at a time by the end effectors 125, for example, based on pre-selection by the user and/or the decision of the toolpath planning system. In some example embodiments, the robotic arms 115 may execute a pre-defined, coded toolpath that is pre-selected by the user or begins automatically when one or more extremities 130 (e.g., feet, hands) are placed on the placement platform 105.

Each end effector 125 may include a suite of force sensitive resistors (FSRs) that individually and/or collectively measure a force applied by a corresponding shaping tool 175 to a nail. In some example embodiments, these measurements may be received by the system 100's toolpath planning system (e.g., via analog input to a microcontroller, such as through a voltage divider, via digital input, such as after passing the measurements through an analog-to-digital converter (ADC)) to calculate the force applied to the nail, motor torque, motor shaft bending moment in two dimensions, motor shaft cantilever force in two dimensions, and axial force. The toolpath planning system may use the force measurements in generating (e.g., updating) the toolpath for the end effector 125. For example, the toolpath planning system may generate the toolpath to modify (e.g., increase or decrease) the force applied to the nail, the motor torque, motor shaft bending moment, motor shaft cantilever force, axial force, or a combination thereof, in accordance with the desired nail shaping.

In some example embodiments, strain gauges, load cells, FSRs, or other force measuring devices may be incorporated into the components of the robotic arms 115 or end effectors 125 to measure forces that the components are subjected to.

The system 100 may include motor drivers (e.g., grinding motor drivers) configured to drive motors included in or connected to the end effectors 125. In some example embodiments, connected to each motor driver may be a motor current sensor that (e.g., continuously or periodically, including at high frequencies) records the current of the motor as the shaping tool 175 is used to perform the nail shaping process. In some example embodiments, connected to each motor driver or each motor may be a motor speed sensor that (e.g., continuously or periodically, including at high frequencies) records the speed of the motor as the shaping tool 175 is used to perform the nail shaping process. In some example embodiments, the motor current measurements and/or motor speed measurements may be sent to the system's toolpath planning system (e.g., via analog input or digital input after conversion) and the safety system. The toolpath planning system may use the motor current and/or motor speed measurements in generating (e.g., updating) the toolpath for the end effector 125. For example, the toolpath planning system may generate the toolpath to modify the current of the motor, which may affect the speed at which the motors are driven. In some example embodiments, the toolpath planning system and/or the safety system may use the motor current measurement and/or motor speed measurements to estimate the force applied to the nail by the shaping tool 175. In some example embodiments, the toolpath planning system and/or safety system may calculate (e.g., estimate) a speed of the motor using the current of the motor (e.g., the current of the motor may indicate the speed of the motor).

The system 100 may include a contact sensing system configured to detect whether a shaping tool 175 contacts a nail of an extremity 130 or skin of the extremity 130. In some example embodiments, an end effector 125 may include an electric circuit that removably connects to conductive surfaces of a shaping tool 175 when it is being utilized in the nail shaping process through a nail shaping tool holder. Shaping tools 175 with an embedded portion of the electric current system may include rotary burrs of varying grit levels, nail filing tools, and nail trimming tools, among others. The electric circuit may serve as a capacitance sensor that (e.g., continuously or periodically, including at high frequencies) measures the capacitance through the conductive surfaces to identify with what material (e.g., skin, nail, air) that the nail shaping tool is in contact. In some example embodiments, the electric circuit may serve as a resistance sensor that (e.g., continuously or periodically, including at high frequencies) measures a resistance (e.g., a value representative of the resistance, such as a current or impedance) through the conductive surfaces to identify the material. Due to the difference in capacitance and resistance between nails and skin, the system 100, using the contact sensing system, may detect when contact is made with skin through the change in measured capacitance and/or resistance. This advantageously provides additional safety for the user, to prevent or minimize contact between the shaping tool 175 and, for example, the skin of a user.

In some example embodiments, the capacitance and/or resistance measurements may be sent to the toolpath planning system (e.g., via analog input). The toolpath planning system may use the capacitance and/or resistance measurements in generating (e.g., updating) the toolpath for the end effector 125. For example, the toolpath planning system may generate the toolpath to modify a trajectory of the end effector 125 (e.g., the shaping tool 175), such as to avoid contacting the skin or to contact the nail.

In some example embodiments, the end effectors 125 and/or robotic arms 115 may include temperature sensors, such as contact-based temperature sensors like thermistors, thermocouples, or other types of thermometer. The temperature sensors may measure the temperature of components of the robotic arm 115 or end effector 125, the temperature of the shaping tool 175, the temperature of the user's skin or nail, or a combination thereof. In some example embodiments, the temperature measurements may be sent to the toolpath planning system (e.g., via analog input). The toolpath planning system may use the temperature measurements in generating (e.g., updating) the toolpath for the end effector 125. For example, the toolpath planning system may generate the toolpath to modify (e.g., increase or decrease) a temperature of robotic arm 115, end effector 125, shaping tool 175, skin of the user, or nail of the user, for example, by modifying motor speed, force applied by the shaping tool 175, and so on.

The system 100 may include a controller 160 that the user may hold and is connected to the system 100 through a wired or wireless connection. The controller 160 may include one or more buttons, such as an emergency full-stop and adjust protocol button for the entire system 100, a full-stop and adjust protocol button for each end effector 125, or a combination thereof. The buttons may be labeled to express to the user their function without the need of assistance from any outside party. In some example embodiments, the buttons may instead be dials, for example, with numbered levels of nail shaping process intensity that change how quickly the end effectors 125, individually or all together, perform the nail shaping process. In some example embodiments, the controller 160 may not be used. In some example embodiments, the controller 160 may have all the commands for the system displayed in a digital interface on a screen. In such an embodiment, the mechanical action of pressing a button, turning a dial, etc., may instead be performed through touching the digital counterpart on the digital interface.

The system 100 may further include a safety system configured to ensure that a user is unharmed during the nail shaping process. For example, force measurements output by the FSRs may be received by the safety system (e.g., via analog input to a microcontroller associated with the safety system, via digital input after conversion) to calculate the force applied to the nail, motor torque, motor shaft bending moment in two dimensions, motor shaft cantilever force in two dimensions, and axial force. In some example embodiments, these measurements may be sent to the control computer which performs the calculations and then sends them to the safety system. Other calculations may be made using this data. In some example embodiments, the safety system may receive current measurements from motor drivers configured to drive motors operatively connected to the end effectors 125 (e.g., via analog input, via digital input after conversion). In some example embodiments, the safety system may receive motor speed measurements from a motor sensor operatively connected to the motors or motor drivers (e.g., via analog input, via digital input after conversion). In some example embodiments, the safety system may receive capacitance measurements and/or resistance measurements from the contact sensing system (e.g., via analog input, via digital input after conversion). In some example embodiments, the safety system may receive temperature measurements from the temperature sensors (e.g., via analog input, via digital input after conversion). In some example embodiments, the safety system may receive signals through a wired connection, a wireless signal, or from the handheld controller.

In some example embodiments, the safety system may determine (e.g., store, retrieve from memory, receive by user or operator selection) a force threshold for force applied to the nail in any direction and check the force measurements (e.g., FSR data) from each end effector 125 against the force threshold. Additionally, or alternatively, the safety system may determine a current threshold for motor current of the end effector 125; a motor speed threshold for motor speed of a motor operatively connected to the shaping tool 175, a temperature measurement threshold for temperature of a robotic arm 115, end effector 125, shaping tool 175, skin of the user, or nail of the user; a resistance threshold for a resistance measurement, a capacitance threshold for a capacitance measurement, a contact-time threshold for time contact with skin as measured by the contact sensing system, or a combination thereof. Additionally, or alternatively, the safety system may receive data from one or more sensors 170 indicating that that the shaping tool 175 has contacted the skin of the extremity 130.

The safety system may receive the measurements and/or data from the respective sensors or systems and compare them against the corresponding thresholds. In some example embodiments, if a measurement or data is within an elevated specified range below the thresholds, the safety system may request an alteration protocol to the one or more toolpaths created by the toolpath planning system for the corresponding end effectors 125 (e.g., through digital input to the microcontroller or direct input to the motor drivers).

If a measurement or data exceeds (e.g., or meets) the thresholds, the safety system may cause the system 100 to halt operation of a corresponding robotic arm 115 and end effector 125. For example, the system 100 may cut power to the motor operatively connected to the end effector 125 and/or move the end effector away from the extremity 130 before cutting power to the robotic arm 115. In some example embodiments, halting operation may include the safety system requesting a full-stop and readjustment protocol for the corresponding end effector 125, which may cause the system 100 to cut power to the end effector 125's grinding motor and quickly move the robotic arm 115 and end effector 125 away from the current nail it is performing the nail shaping process on.

In some example embodiments, any safety system protocol request may be received by the toolpath planning system in the control computer. In some example embodiments, the toolpath planning system may utilize the sensors 170 to re-scan the one or more nails and end effectors 125 whose measurement engaged the protocol to update position, orientation, and feature data. The new scan may be received by the toolpath planning system. The toolpath planning system may modify the toolpath (e.g., alter the current toolpath or generate a new toolpath) depending on the protocol received from the safety system for each end effector 125 the protocol applies to. The modified toolpath may be sent to the corresponding robotic arm 115 and end effector 125 to begin executing along the toolpath and continue performing the nail shaping process. In some example embodiments, if the safety system is triggered multiple times under conditions that the control algorithm identifies as abnormal, the system may shut down and request maintenance from the user, operator, or a technician.

In some example embodiments, analog values from the sensors and/or systems (e.g., sensors 170, FSRs, current sensors, contact sensing system, temperature sensors) may be connected to analog circuits separate from the microcontrollers or control computers. The analog circuits may store the thresholds defined in an analog manner and may activate one or more relays to shut down a corresponding grinding motor if a threshold is exceeded. The analog circuits may use op amps or other integrated circuits (ICs) to compare received analog signals to their reference thresholds.

In some example embodiments, a tool rack 165 may also include a conductivity probe. This probe may be removably connected to an end effector 125 like any other shaping tool 175. The probe may have a ball or other shape on its end and be used to incrementally touch different points on the digits and nails. At each point when the probe touches either skin or nail, force sensors (e.g., the FSRs) may detect if contact has been made. The system 100 may use forward kinematics to calculate the 3D position of the probe using known joint angles of the robotic arm 115 operatively connected to the end effector 125. The system 100 may also log the capacitance measurement and/or resistance measurement through the probe to determine if it is touching skin or nail material. By touching the probe incrementally along the digits, the system may “scan” the 3D surface of the digits and nails and log which points are nails and which are skin. In some example embodiments, the 3D position of the end of the probe may also be found using the sensors 170 (e.g., visual cameras or depth cameras).

In some example embodiments, the computer vision model, toolpath planning system, and the system for storing the pre-selections made by the user or operator may be housed on one or more control computers. In some other examples, the model and systems may be housed in an external cloud computing server which interfaces with the system 100 when the user places the at least one extremity 130 on the placement platform 105. In some example embodiments, the control computers, microcontrollers and their analog input devices, safety systems, contact sensing systems, drivers, current sensors, and relays may be housed inside one or more electronics housings 135 near the placement platform 105 or robotic arm platform 120.

Additionally, in performing the nail shaping process, the end effectors 125 (e.g., using shaping tools 175) may create nail dust that can dirty the mechanical parts and/or create visibility issues for the sensors 170 (e.g., 3D depth cameras, 2D cameras, and so on). In some example embodiments, the system 100 may include vacuum system 140 that is configured to draw airflow away from the extremities 130. For example, the vacuum system 140 may draw the nail dust through one or more slots between the robotic arms 115 and the nails, or through another intake system near the robotic arm platform 120 or placement platform 105. In some example embodiments, the vacuum system 140 may be a water-based circulation system. The dust may travel through the slots and a duct system 150 into a nail dust chamber 155 (e.g., removably) connected to the system 100 away from the mechanical components and the user. The nail dust chamber 155 may be removed and the nail dust dumped or washed out for cleaning. In some examples, one or more ducts of the duct system 150 may be a part of the vacuum system 140.

In some example embodiments, a blower system 145 may be located near the nails and configured to direct airflow onto the extremities 130. One or more slots may push air towards the nails for cooling and/or controlling the direction of nail dust during the nail shaping process. The slots may be connected through the duct system 150 to a fan system that draws in air from outside of the system 100. The fan system may be a part of the blower system 145. In some examples, one or more ducts of the duct system 150 may be a part of the blower system 145.

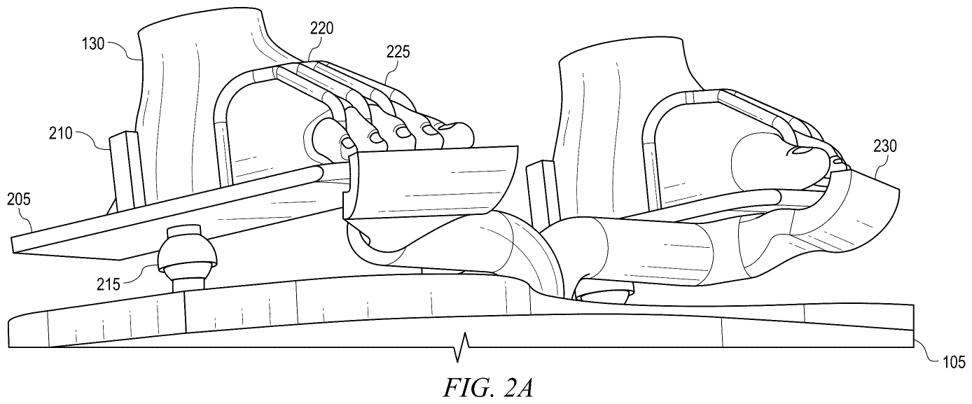

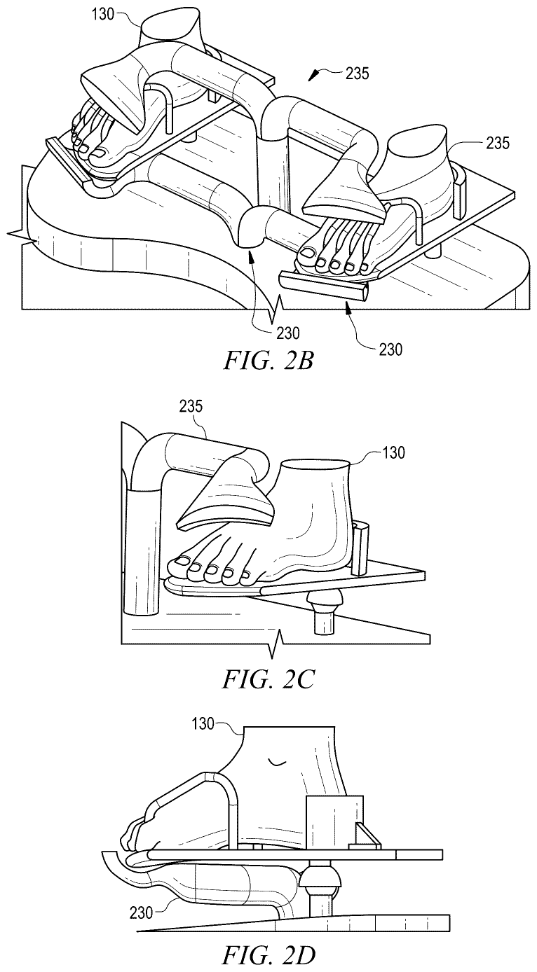

FIGS. 2A, 2B, 2C, and 2D depict aspects of a system for nail shaping in accordance with one or more aspects of the present disclosure. For example, the aspects may be included in or implemented by a system that supports automated nail shaping described herein, including the system 100. FIGS. 2A, 2B, 2C, and 2D depict a front view, an upper-front perspective view, and side views, respectively, of a portion of the system 100 including the placement platform 105.

The placement platform 105 may have one or more raised platforms 205 for placement of an extremity 130 that are connected to the main body of the placement platform 105, such as through a joint 215 (e.g., a ball joint) on the underside of each raised platform 205. The joints 215 allow the extremity 130 to be placed at different angles if needed for the user's comfort. In some example embodiments, the raised platforms 205 may have gimble joints on the underside, with an angle sensor connected to some or all of the rotational joints and the sensors connected to a microcontroller or control computer. The placement platform 105 may otherwise have no raised platforms 205.

The placement platform 105 may include a brace 210 (e.g., a cushioned brace) that the user's heels or wrists may rest against, with their nails oriented toward the robotic arm platform 120. In some example embodiments, the placement platform 105 may not include the brace 210.

The system 100 may include one or more straps 220 which are bound around the extremity 130 and secure the extremity 130 to the platform. A strap 220 may be rigid or flexible. In some example embodiments, a strap 220 may cover a dorsum of the extremity 130.

In some example embodiments, the system 100 may include a digit-positioning structure 225. The digit-positioning structure 225 may be a digit holder configured to secure one or more digits of the extremity 130 in place. Additionally, or alternatively, the digit-positioning structure 225 may be a digit spacer configured to separate one or more digits of the extremity 130. In some example embodiments, the digit-positioning structure 225 may be straps (e.g., connected to the strap 220) that slide between the user's digits to create a space between each digit, for example, to make the nail shaping process easier for the system 100 to perform (e.g., with more space to move the end effectors 125 and shaping tools 175 without contacting each other or an unwanted portion of the extremity 130). In some example embodiments, the digit-positioning structure may include pegs removably inserted into holes in the surface under the extremity 130. The user may slide their digits between the pegs. The pegs may be removed and inserted into any of the holes on the surface to provide the right alignment for any user within a certain range of extremity and digit morphologies. In some example embodiments, the digit-positioning structure 225 may include one or more rings or slots that each digit may be inserted into, or a series of ridges that each digit can be placed between. In some example embodiments, the system 100 may not include strap 220 that binds the extremity 130 to the placement platform 105. In some example embodiments, the system 100 may not include a digit-positioning structure 225 that puts space between or holds the digits in place.

Additionally, or alternatively, the digit-positioning structure 225 may be (e.g., a part of) a vibration system configured to vibrate one or more of the digits of the extremity 130 during operation of the robotic arm 115 and the end effector 125. In some example embodiments, vibrating one or more of the digits may include massaging the one or more digits. For example, applying the shaping tool 175 to the nail may cause a tickling sensation or other uncomfortable sensation to a user during the nail shaping process. Vibrating (e.g., massaging) the digits using the digit-positioning structure 225 may reduce or mitigate these sensations, for example, by canceling or drowning them out, thereby rendering the nail shaping process more enjoyable for the user.

The vacuum system 140 may include one or more vacuum ducts 230 configured to draw airflow (e.g., nail dust) away from the extremity 130. In some example embodiments, the vacuum ducts 230 may be a part of the duct system 150. In some example embodiments, the vacuum ducts 230 may be located beneath the extremity 130 (e.g., under the digits of the extremity 130). The blower system 145 may include one or more blower ducts 235 configured to direct airflow onto the extremity 130. In some example embodiments, the blower ducts 235 may be a part of the duct system 150. In some example embodiments, the blower ducts 235 may be located above the extremity 130 (e.g., above the digits of the extremity 130). Other arrangements and configurations of the vacuum ducts 230 and blower ducts 235 are possible.

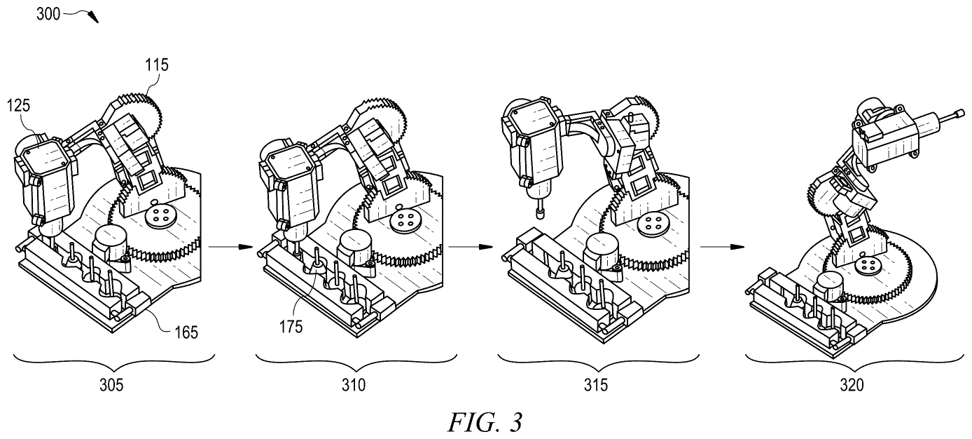

FIG. 3 depicts an example embodiment of an operation sequence 300 for operating a system for nail shaping in accordance with one or more aspects of the present disclosure. For example, the operation sequence 300 depicts a sequence for selecting and/or changing a shaping tool 175 of an end effector 125. The operation sequence 300 may be implemented by a system that supports automated nail shaping described herein, including the system 100.

In some example embodiments, a tool rack 165 may include a clamping system (e.g., a solenoid actuated clamping system) that clamps or releases all the shaping tools 175 at the same time. When a shaping tool 175 is released, it continues to be held in the same position by the tool rack 165, but it may be removed by an end effector 125. In some example embodiments, the clamping system may be actuated by a motor and individual actuators may be used to clamp one or multiple shaping tools 175 at a time. Other actuators may be used to hold and release one or more shaping tools 175 at a time. In some example embodiments, the shaping tools 175 may be held in place by an electromagnet that can turn on when a robotic arm 115 releases a shaping tool 175 for storage in the tool rack 165, or the electromagnet can turn off if a robotic arm 115 is trying to remove a tool. In some example embodiments, a pin, fork, or other mechanism can be actuated to hold a shaping tool 175 in its place in the tool rack 165 when the tool is to be removed from a robotic arm 115. This pin, fork, or other mechanism may be removed by an actuator when releasing a shaping tool 175.

A robotic arm 115 may move an end effector 125 from the extremity 130 to the assigned tool rack 165. The robotic arm 115 may perform a nail shaping tool replacement of the shaping tool 175 currently held by the end effector 125 with another shaping tool 175, for example, for a different use in the generated toolpath process. For example, the robotic arm 115 may insert the currently held shaping tool 175 into its assigned slot on the tool rack 165. The clamping system may secure the shaping tool 175, and the robotic arm 115 may move the end effector 125 away with enough force to disconnect it (e.g., magnetically) from the shaping tool 175.

In the example embodiment of FIG. 3, at 305, the robotic arm 115 may move the end effector 125 to the replacement shaping tool 175. At 310, the robotic arm 115 may move the end effector 125 to insert a shaft of the shaping tool 175 into a shaping tool holder of the end effector. The clamping system may release one or more of the shaping tools 175, including the replacement shaping tool 175. In some example embodiments, a magnet inside the shaping tool holder removably connects the shaping tool 175 to the end effector 125. In some example embodiments, the shaping tool holder may include a chuck that may be tightened and loosened by a motor, solenoid, or other actuator to hold and release the shaping tool 175. At 315, the robotic arm 115 moves the end effector 125 away from the tool rack 165. At 320, the robotic arm returns to the nail shaping process, beginning in either the same position as was generated by the toolpath planning system previously or at a new position generated by the toolpath planning system in the time it took to perform the nail shaping tool replacement.

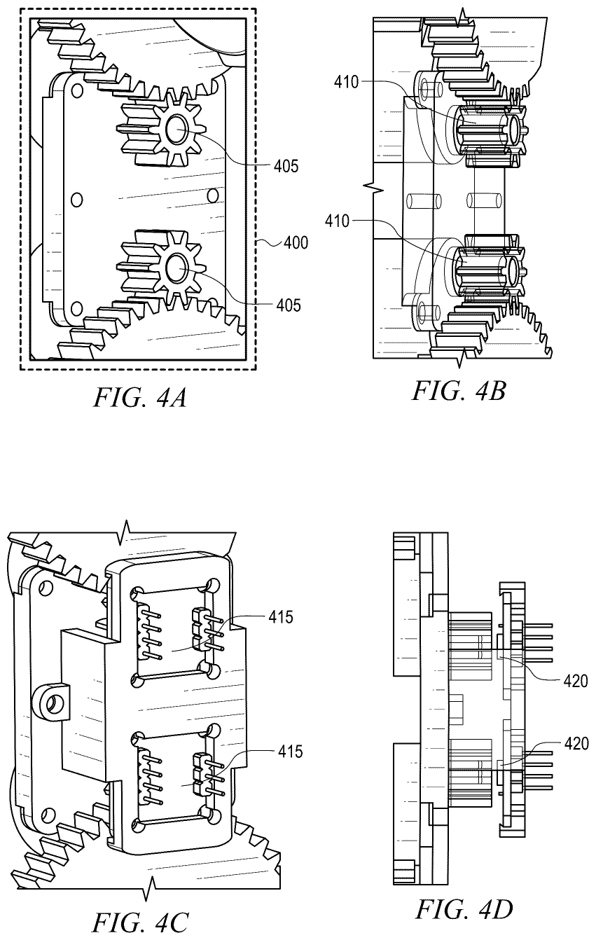

FIGS. 4A, 4B, 4C, and 4D depict aspects of a system for nail shaping in accordance with one or more aspects of the present disclosure. For example, the aspects may be included in or implemented by a system that supports automated nail shaping described herein, including the system 100. FIGS. 4A, 4B, and 4C depict front perspective views of a portion of a robotic arm 115. FIG. 4D depicts a side view of the portion of the robotic arm 115.

In some example embodiments, a robotic arm 115 may include joints 400 driven by motors (e.g., stepper motors, brushless DC (BLDC) motors, brushed motors, servos, or other position control motors), and each joint may use an encoder (e.g., a magnetic encoder, an optical encoder, a continuous potentiometer, a non-continuous potentiometer) to measure angular displacement. For example, the robotic arm 115 may include one or more magnets 405 included or coupled with motor shafts 410. The robotic arm 115 may include an integrated circuit (IC) chip 420 coupled with each magnet 405 and an encoder printed circuit board (PCB) 415 coupled with each IC chip 420 which may be used to measure an angular displacement of the joint of a robotic arm 115. In some example embodiments, the encoders may be any other incremental or absolute encoder, such as a two phase quadrature encoder or a potentiometer.

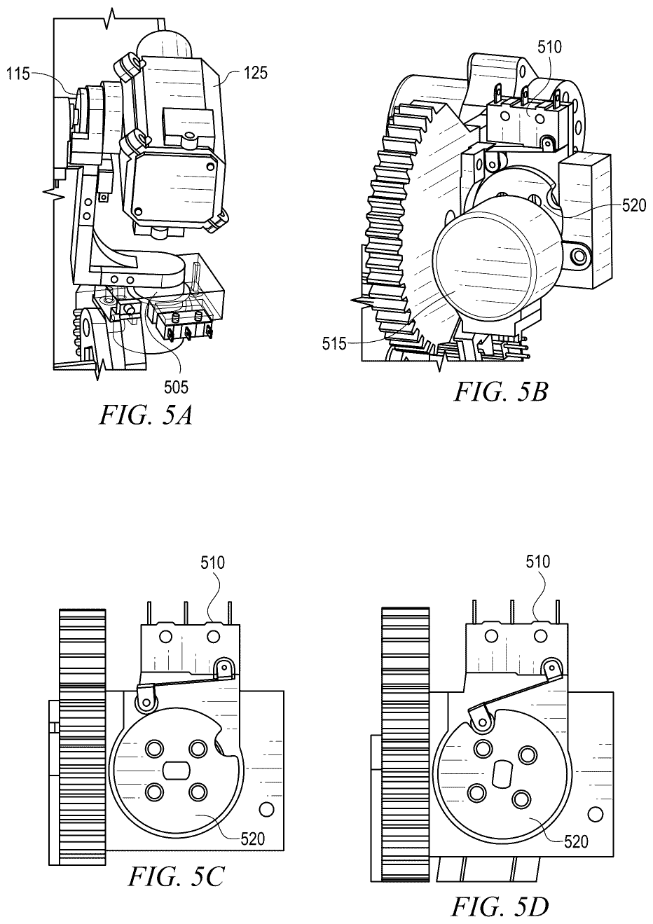

FIGS. 5A, 5B, 5C, and 5D depict aspects of a system for nail shaping in accordance with one or more aspects of the present disclosure. For example, the aspects may be included in or implemented by a system that supports automated nail shaping described herein, including the system 100. FIG. 5A depicts a perspective view of a robotic arm 115 operatively connected to an end effector 125 and a joint 505 of the robotic arm 115. FIG. 5B depicts a front perspective view of the joint 505. FIGS. 5C and 5D depict front views of the joint 505 (with the motor 515 removed for illustrative clarity).

In some example embodiments, a robotic arm 115 may include joints (e.g., joints 505) driven by motors (e.g., stepper motors, brushless DC motors, brushed motors, servos, or other position control motors), and each joint 505 may use a limit switch 510 to detect one reference displacement per revolution of a motor 515. The limit switches 510 may be used to initialize a set point for the rotation of the motor 515. Here, the system 100 may use a feedforward control system to track the angular displacement relative to the setpoint of the limit switch 510 for that joint 505 (e.g., based on a position of a shaft retaining plate 520). For example, FIG. 5C depicts the limit switch 510 in a neutral position (setpoint position). FIG. 5D depicts the limit switch 510 in an index position.

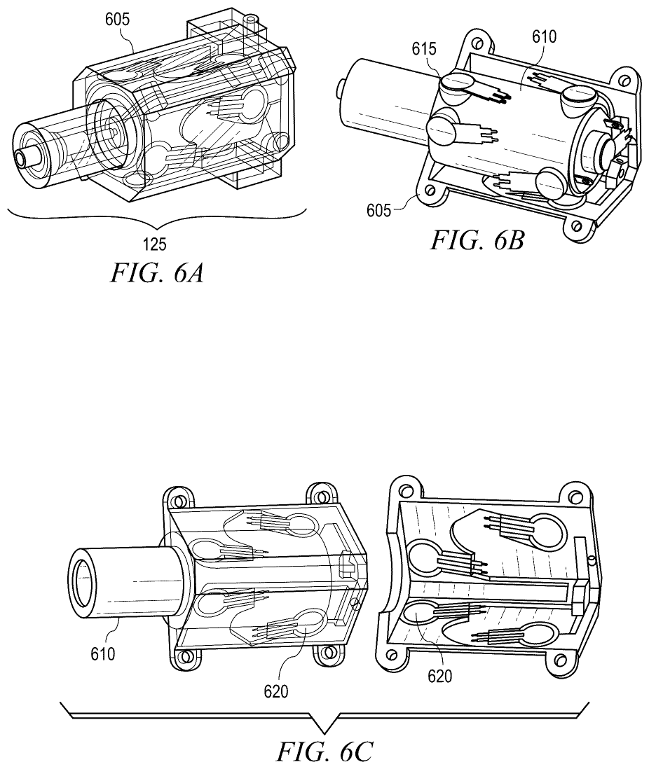

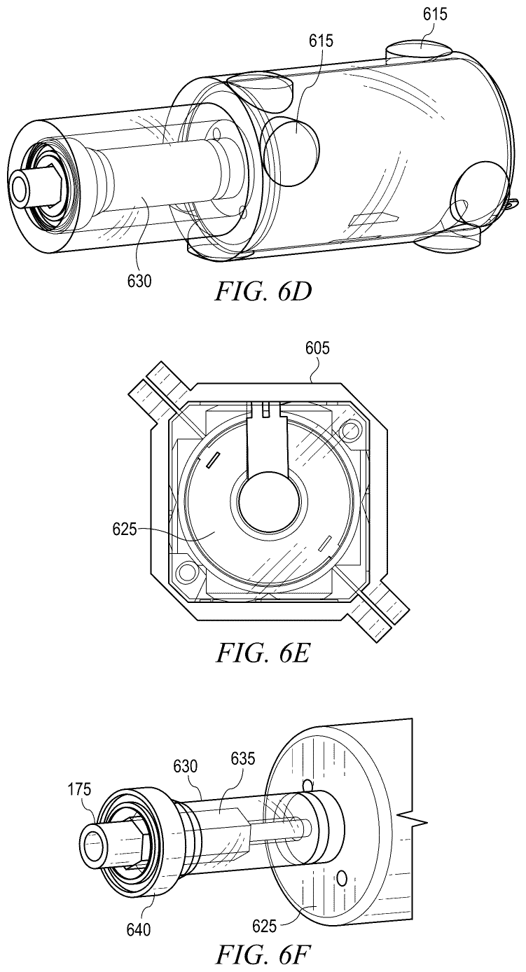

FIGS. 6A, 6B, 6C, 6D, 6E, and 6F depict aspects of an example embodiment of an end effector in accordance with one or more aspects of the present disclosure. For example, the end effector may be an example of an end effector 125 included in or implemented by a system that supports automated nail shaping described herein, including the system 100. FIGS. 6A through 6D depict various perspective views of the end effector. FIG. 6E depicts a back view of the end effector. FIG. 6F depicts a perspective view of an interior of an inner motor housing 610 of the end effector.

An end effector may be connected to a robotic arm 115. The end effector may include a motor 625 (e.g., a grinding motor), which may have a direct drive coupling with a shaping tool holder 635. In some example embodiments, the shaping tool holder 635 may removably connect a shaft (e.g., a hex shaft, a circular shaft, or any other polygonal shape) of a shaping tool 175 to the end effector through a socket (e.g., a hex socket, a circular socket, or any other polygonal shape) with a magnet at the bottom of the socket, or some type of chuck. In some example embodiments, the shaft and socket may be four millimeters in size or another size and may be round or any other polygon shape other than a hexagon, like a square.

In some example embodiments, a shaping tool 175 may have a shaft that is removably connected to the shaping tool holder 635 with a squeezing force the holder 635 exerts on the tool. In some example embodiments, the motor 625 may include a geared coupling with the shaping tool 175. The geared coupling may be a planetary gearbox, a traditional spur or helical gear train, a bevel gear train, a helical gear train, a pulley or sprocket coupling, or any other mechanical coupling. In some example embodiments, the motor 625 may have a non-geared flexible coupling between the motor 625 and shaping tool 175.

In some example embodiments, the end effector 125 may include an outer housing 605. The outer housing 605 may encircle (e.g., hold, include within) an inner housing 610, one or more FSRs 620, or both. The outer housing 605 may be connected to the distal end of a robotic arm 115 relative to a frame or robotic arm platform to which the robotic arm is connected. In some example embodiments, the motor 625, and shaping tool components may be contained in inner housing 610. In some example embodiments, the inner housing 610 may be made of a rigid material. In some example embodiments, the inner housing 610 may be cylindrical in shape. The inner housing 610 may contact the inside of the outer housing 605 with contact patches 615 (e.g., bumps) placed at specific locations on the surface of the inner housing. The contact patches 615 on the inner housing 610 may contact FSRs 620 connected to the inside of the outer housing 605. Any other type of force or pressure sensor may be used to measure the force between the inner housing 610 and outer housing 605.

The shaping tool components included in the inner housing 610 may include a shaft coupler 630 coupled with the motor 625, the shaping tool holder 635, the shaping tool 175, and a bearing 640. The bearing 640 may enable the shaft coupler 630, which is rotated by the motor 625, to spin relative to the inner housing 610. The inner housing 610 may be connected to body of the motor 625, each of which may not rotate. In some example embodiments, the bearing 640 may be a bushing. In some example embodiments, the bearing 640 may be excluded, for example, if the shaft coupler 630 is rigidly attached to the motor shaft. For example, the bearing 640 may reduce or prevent the shaft coupler 630 (e.g., and by extension the shaping tool 175) from wobbling during the nail shaping process. If the bearing 640 is excluded, the shaft coupler 630 may be rigidly attached to the motor shaft to reduce or prevent wobbling. The shaping tool holder 635 may be included within the shaft coupler 630.

The motor 625 may change its speed and direction of rotation, for example, based on selections of the user or operator, decisions made by the toolpath planning system, or both. The motor 625 may be connected to the toolpath planning system through a brushed motor driver, which may also be a stepper driver, BLDC driver, H-bridge, etc.

In some example embodiments, the suite of FSRs 620 may be arranged in four sets of two and one standalone sensor. As one example, in each set of two, one force sensor may be close to the shaft side of the motor 625, and the other is on the far side of the motor 625 to the shaft. Each set may have one FSR 620 placed slightly to the right of a centerline of the motor 625 and the other sensor placed slightly to the left. The sets may be evenly spaced around the circumference of the inner housing 610. Each adjacent set alternates which FSR 620 is offset to the right or left. One standalone FSR may be concentric with the motor 625 and contact the back of the motor 625. In some example embodiments, other force sensor types, load cells, strain gauges, or the measured displacement of a spring may be used to measure force applied by the shaping tool 175 to the nail.

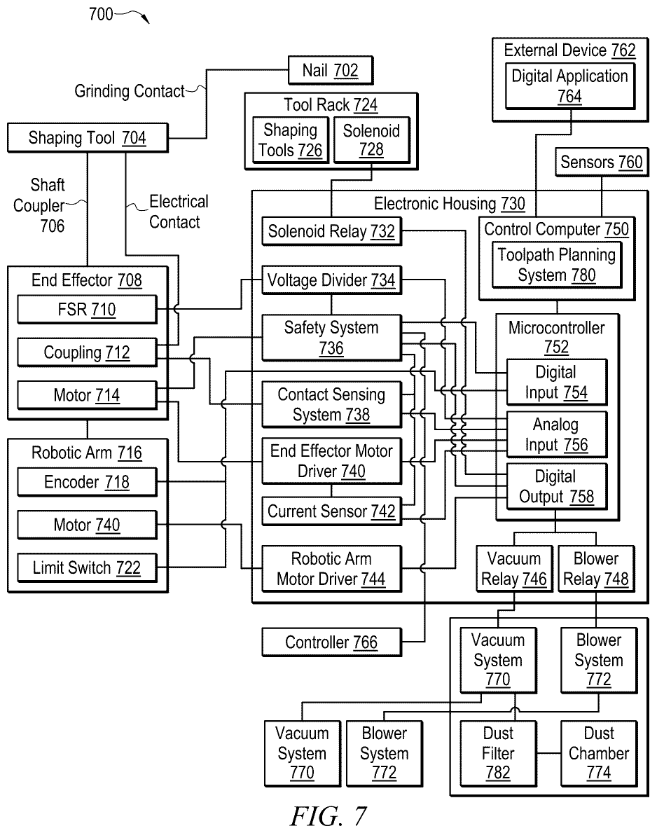

FIG. 7 depicts a block diagram of a system 700 for nail shaping in accordance with one or more aspects of the present disclosure. The system 700 may include or be implemented by aspects of a system 100. The components of the system 700 (e.g., end effector 708, robotic arm 716, and so on) may be examples of the corresponding components described herein (e.g., end effector 125, robotic arm 115, and so on).

The system 700 supports automated nail shaping of a nail 702. For example, the system 700 includes an end effector 708 that includes a shaping tool 704 operatively connected to a motor 714 via a shaft coupler 706. In some example embodiments, the motor 714 may be coupled with the shaping tool 704 via a coupling 712. In some example embodiments, the coupling 712 may provide an electrical connection to the shaping tool 704, such as to support resistance and/or capacitance sensing. In some example embodiments, the coupling 712 may be a slip coupling, a wire, a conductive bearing, a conductive bushing, or some other conductive component that is connected to the shaping tool 704 (e.g., and the motor 714, a motor shaft, a shaft coupler). The end effector 708 may include one or more FSRs 710 to measure a force applied to the nail 702 by the shaping tool 704.

The system 700 may further include a robotic arm 716 that is operatively connected to the end effector 708. For example, the robotic arm 716 may be used to move the end effector 708 (e.g., in accordance with a nail shaping process). The robotic arm 716 may include various components to control its movement, such as one or more encoders 718, one or more motors 720, one or more limit switches 722, or a combination thereof.

The system 700 may include a tool rack 724 that supports changing the shaping tool 704 in accordance with a desired nail shaping process (e.g., as described above with respect to FIGS. 1A-3). For example, the tool rack 724 may include shaping tools 726 within a clamping system, such as a solenoid 728, configured to hold the shaping tools 726. The system 700 may move the robotic arm 716 and end effector 708 in conjunction with controlling the clamping system to select (e.g., change, switch) among the shaping tools 726 to connect to the end effector 708.

The system 700 may include one or more systems configured to direct airflow near the extremity during the nail shaping process. For example, the system 700 may include a vacuum system 770 configured to direct airflow away from the extremity so as to pull nail dust into the vacuum system 770 and into a dust chamber 774. In some example embodiments, the system 700 may include a dust filter 782 that enables the air sucked into the vacuum system 770 to exit the vacuum system 770 while leaving the nail dust in the dust chamber 774. The system 700 may include a blower system 772 configured to direct airflow onto the extremity, for example, to cool the extremity and/or the shaping tool, to direct nail dust to the vacuum system, or both. The vacuum system 770 may include vacuum ducts 776 through which the air and nail dust may be directed from the extremity to the dust chamber 774. The blower system 772 may include blower ducts 778 through which the air may be blown toward the extremity.

The system 700 may include a controller 766 configured to adjust a protocol of the system 700, the end effector 708, or both. For example, the controller 766 may be usable by the user to halt operation of the system 700 or end effector 708 (e.g., initiate a full-stop protocol), change an intensity of the nail shaping process, or both. In some example embodiments, the controller 766 may be configured to adjust any electrical system of the system 700, such as the robotic arm 716, the tool rack 724, the vacuum system 770, and/or the blower system 772, instead of or in addition to the end effector 708.

The system 700 may include sensors 760 configured to generate a 3D scan of at least a portion of an extremity. The 3D scan may be used to generate a toolpath of the end effector 708 in accordance with a desired nail shaping process.

The system 700 may include an external device 762 operable by a user or operator to make one or more selections regarding the nail shaping process (e.g., desired sub-processes, nail features, or both). For example, the external device 762 may include a digital application 764 through which the user or operator may make the selections. The system 700 may perform the nail shaping process in accordance with the selections.

The system 700 may include electronics configured to control operation of, and/or communicate with, the end effector 708, the robotic arm 716, the tool rack 724, the vacuum system 770, the blower system 772, the controller 766, the sensors 760, the external device 762, or a combination thereof. For example, the system 700 may include one or more electronics housings 730 that includes (e.g., houses or contains) various electronic components. For instance, the system 700 may include a control system including one or more control computers 750, one or more microcontrollers 752, or both. The control computer 750 and/or microcontroller 752 may be configured to control operation of the components of the system 700.

For example, the electronics housing 730 may further include: a solenoid relay 732 configured to communicate signals with the tool rack 724 (e.g., the solenoid 728); a voltage divider 734 configured to provide analog signals to the microcontroller 752 and a safety system 736; the safety system 736 configured to monitor various system measurements to determine whether to halt operation of the end effector 708 and robotic arm 716; a contact sensing system 738 configured to detect whether the shaping tool 704 contacts the skin or nail of an extremity; an end effector motor driver 740 configured to drive a motor 714 of the end effector 708; a current sensor 742 configured measure a current of the motor 714; a robotic arm motor driver 744 configured to drive a motor 720 of the robotic arm 716; a vacuum relay 746 configured to communicate with the vacuum system 770; a blower relay configured to communicate with the blower system 772; or a combination thereof. In some example embodiments, the safety system 736 may receive signals from the controller 766.

In some example embodiments, the microcontroller 752 may be communicatively coupled with (e.g., via wired connection, wireless connection, digital connection, analog connection) the solenoid relay 732, the voltage divider 734, the safety system 736, the contact sensing system 738, the end effector motor driver 740, the current sensor 742, the robotic arm motor driver 744, the vacuum relay 746, and the blower relay 748. The microcontroller 752 may receive digital inputs 754 from the encoder 718, the limit switch 722, and the safety system 736. The microcontroller 752 may receive analog inputs 756 from the voltage divider 734, the contact sensing system 738, the end effector motor driver 740, and the current sensor 742. The microcontroller 752 may be configured to transmit digital outputs 758 to the safety system 736, the robotic arm motor driver 744, the vacuum relay 746, and the blower relay 748. In some example embodiments, one or more of the analog inputs 756 may be converted to digital inputs, such as using an ADC, before being input to the microcontroller 752.

In some example embodiments, the control computer 750 may be communicatively coupled with the sensors 760 and the external device 762. In some example embodiments, the control computer 750 may be able to interface with the digital application 764 to communicate with the external device 762. In some example embodiments, the control computer 750 may be configured to communicate with and control operation of the microcontroller 752. In some example embodiments, communications may be routed to and through the control computer 750 (e.g., instead of the microcontroller 752). In some example embodiments, the control computer 750 may include the microcontroller 752.

In some example embodiments, the microcontroller 752 may be an Arduino® or Teensy®, among others. In some example embodiments, the control computer 750 may be a Raspberry Pi®, NVIDIA Jetson® or other NVIDIA small computer, or any other type of computer. The microcontrollers may be wired to communicate data with the control computer 750. Motors 720 in the robotic arms 716 may be wired either to the microcontroller 752 or the control computer 750 through respective end effector motor drivers 740 that may be controlled by a control algorithm either on the microcontroller 752, the control computer 750, or a networked or wirelessly connected computer. In some example embodiments, all coded systems for directing the nail shaping process by the physical components of the system 700 (e.g., robotic arms, sensors, motors, end effectors, vacuum relays, blower relays) may be housed on or transferred through one or more microcontrollers 752.

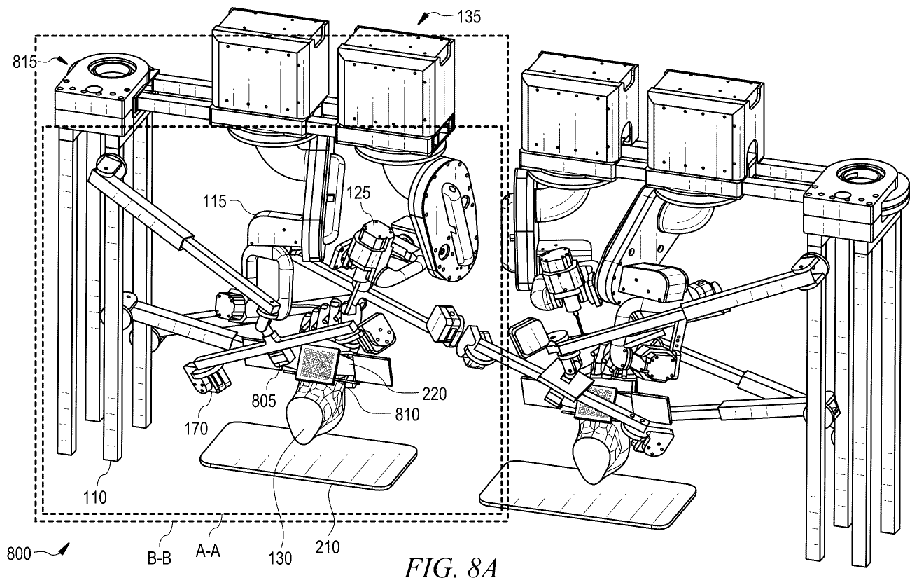

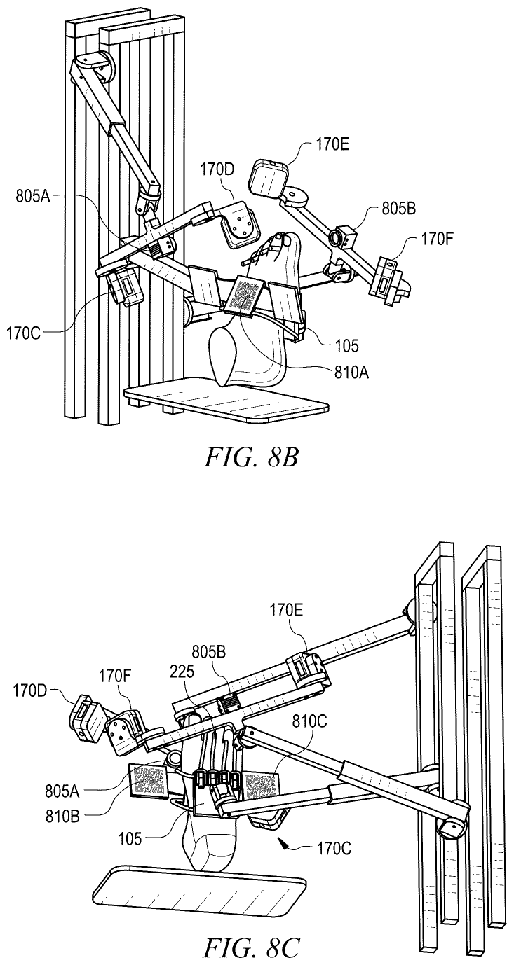

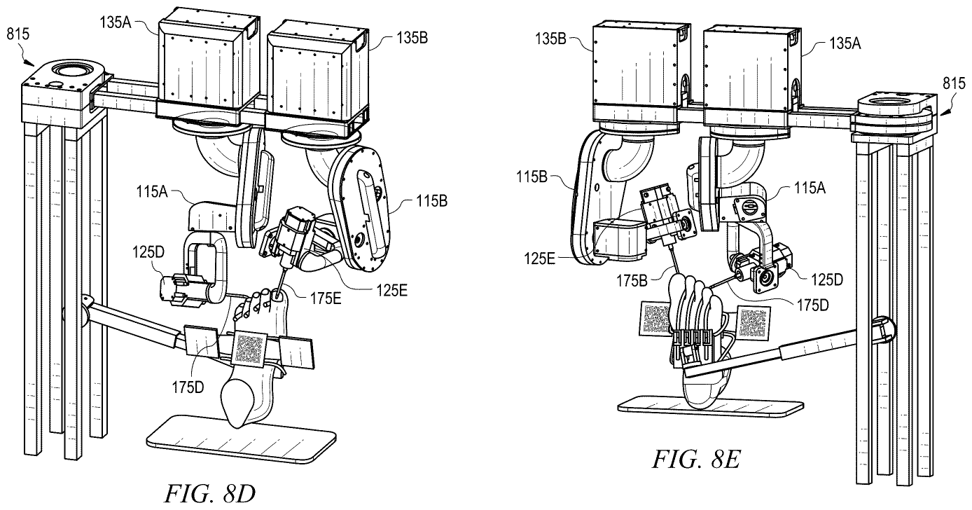

FIGS. 8A, 8B, 8C, 8D, and 8E depict an example embodiment of a system 800 for nail shaping in accordance with one or more aspects of the present disclosure. The system 800 supports automated nail shaping of one or more nails of a user. FIG. 8A depicts an upper-front perspective view of the system 800. FIGS. 8B and 8C depict upper-front and bottom perspective views the portion of the system 800 depicted along line A-A of FIG. 8A that excludes the robotic arms 115, end effectors 125 and electronics housing 135 for illustrative clarity. FIGS. 8D and 8E depict upper-front and bottom perspective views of the portion of the system 800 depicted along line B-B of FIG. 8A that excludes the sensors 170 and sensors 805 for illustrative clarity.

The system 800 may implement or be implemented by aspects of a nail shaping system described herein, including the system 100. For example, the system 800 may include placement platforms 105, a frame 110, robotic arms 115, end effectors 125, electronics housings 135, sensors 170, braces 210, straps 220, and digit-positioning structures 225, which may be examples of the corresponding components described herein. In some example embodiments, the braces 210 of the system 800 may be a rest for an extremity 130, such as a footrest or handrest. Additionally, the system 800 may support automated nail shaping by generating toolpaths for the end effectors 125 and operating the robotic arms 115 and end effectors 125 in accordance with the generated toolpaths to perform a nail shaping process on nails of one or more extremities 130, as described herein.

Here, the system 800 may depict an alternative configuration to support the automated nail shaping. For example, the frame 110 and the robotic arms 115 may be oriented such that the robotic arms 115, as attached to the frame 110, are located above the extremities 130 relative to a direction along which the digits extend.

In some example embodiments, the system 800 may include multiple sensors 170 per extremity 130. For example, the example of system 800 includes sensors 170C, 170D, 170E, and 170F. The sensors 170C, 170D may be located above the extremity 130 (e.g., above a dorsum of the extremity 130) and positioned to face the dorsum of the extremity 130. The sensors 170E, 170F may be located below the extremity 130 (e.g., below a bottom of a foot, a palm of a hand) and positioned to face the bottom of the extremity 130. Other quantities and locations of the sensors 170 are possible. The sensors 170 may be configured to generate 3D scans of at least a portion of the extremity 130 to use in generating toolpaths for the end effectors 125.

The system 800 may further include one or more data matrices 810 to support generating the 3D scans. For example, the system 800 may include a data matrix 810A positioned to face the sensors 170 located above the extremity 130 (e.g., sensors 170C, 170D) and data matrices 810B, 810C positioned to face the sensors 170 located below the extremity 130 (e.g., sensors 170E, 170F). Other quantities and locations of data matrices 810 are possible. The data matrices 810 may facilitate accurate 3D scan generation. For example, the size and dimensions of the data matrices 810 may be known to the system 800 before generating the 3D scan (e.g., may be stored in memory, input by a user or operator). Accordingly, the computer vision model may use the known dimensions of the data matrices 810 to accurately determine the size, position, and orientation of the other objects included in the 3D scan. In some example embodiments, a data matrix 810 (e.g., the data matrix 810A) may be affixed to the strap 220. In some example embodiments, the data matrices 810 may be positioned to be located within a field of view of at least one sensor 170. In some example embodiments, the data matrices 810 may be QR codes, AprilTags, or other visual representations that support accurate 3D scan generation.

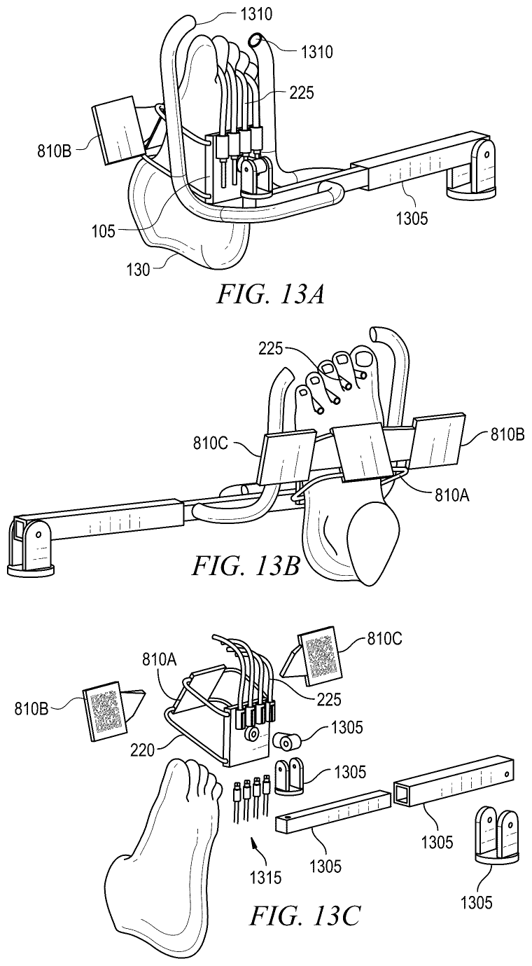

The system 800 may further include one or more sensors 805 (e.g., sensor 805A, 805B). The sensors 805 may be temperature sensors, such as thermal cameras, configured to measure a temperature of one or more aspects of the system 800 during the nail shaping process (e.g., a temperature of a robotic arm 115, an end effector 125, a shaping tool 175, a digit of the extremity 130, a nail of the extremity, the skin of the extremity 130). In some example embodiments, the sensors 805 may output temperature measurements to a toolpath planning system, a safety system, or both. In some example embodiments, the sensors 170 and/or the sensors 805 may be connected to the frame 110 via one or more frame connectors (e.g., a frame connector 1305 described with reference to FIGS. 13A-13C).

In some example embodiments, the system 800 may include an electronics housing 135 per robotic arm 115 to control operation of the corresponding robotic arm 115 and end effector 125. For example, the system 800 may include robotic arms 115A, 115B operatively connected to end effectors 125D, 125E, respectively. The end effectors 125D, 125E may include shaping tools 175D, 175E, respectively. The system 800 may include an electronics housing 135A that includes electronics configured to control operation of the robotics arm 115A and end effector 125D and an electronics housing 135B that includes electronics configured to control operation of the robotics arm 115B and end effector 125E. In some example embodiments, the electronics of the electronics housings 135A, 135B may operate independently (e.g., and concurrently) to control the robotic arms 115A, 115B and end effectors 125D, 125E. In some example embodiments, the electronics housings 135 may be located elsewhere on the frame 110 or may not be attached to the frame 110.

In some example embodiments, the frame 110 may include a hinge 815. Using the hinge 815, a portion of the frame 110 to which the robotic arms 115 are connected may be moved (e.g., pivoted) away from the extremity 130. For example, using the hinge 815, the robotic arms 115 and end effectors 125 may be moved out of the way so that a user or operator may access the nails of the extremity 130. In some example embodiments, the hinge 815 may be motorized. In some example embodiments, the motorized hinge 815 may be controlled via electronics of the system 800 (e.g., housed in the housing 135 or communicable with the electronics in the housing 135) or may be independently controllable (e.g., using an interface that controls the motor of the hinge 815).

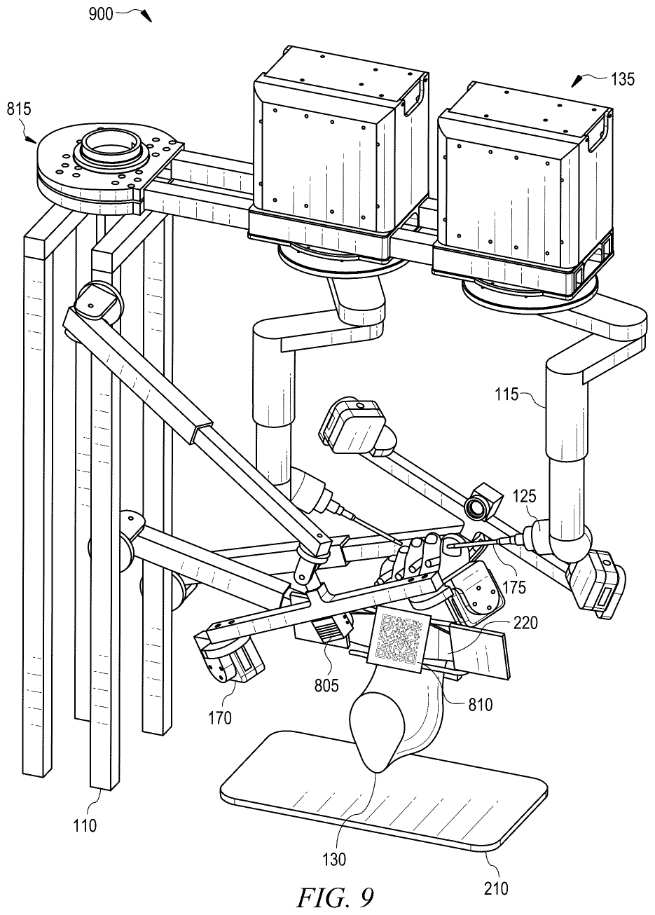

FIG. 9 depicts an example embodiment of a system 900 for nail shaping in accordance with one or more aspects of the present disclosure. The system 900 may be an example of the system 800 including an alternative type of robotic arm 115. For example, in the example of FIGS. 8A through 8E, the system 800 is shown to include an articulated robotic arm having five or more degrees of freedom, such as by having three translational degrees of freedom and two rotational degrees of freedom. In the example embodiment of FIG. 9, the robotic arm 115 of the system 900 may be a SCARA. The SCARA robotic arm 115 may have five degrees of freedom as it may include, for example, four rotary axes (e.g., four rotational degrees of freedom) and one linear axis (e.g., one translational degree of freedom). In some example embodiments, a toolpath planning system may generate a toolpath for a robotic arm 115 based on the degrees of freedom of the robotic arm 115. For example, the toolpath planning system may calculate the joint angles and/or joint positions of a robotic arm 115 in accordance with the type of robotic arm 115 and the corresponding degrees of freedom.

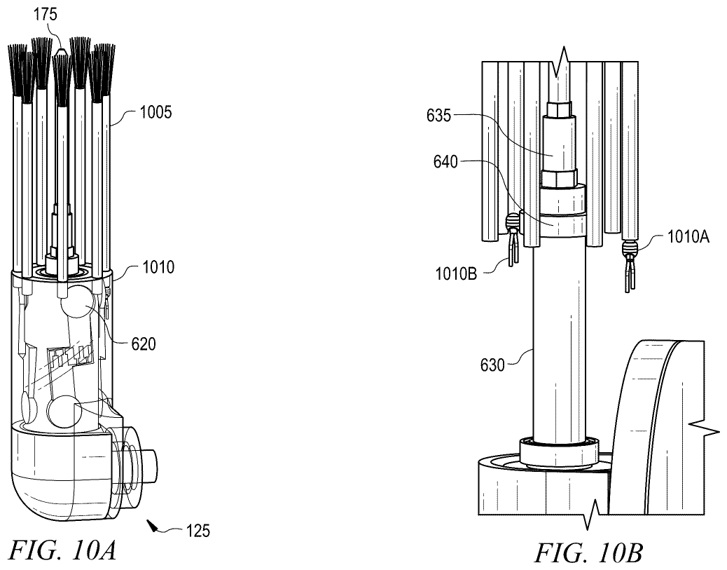

FIGS. 10A and 10B depict aspects of an example embodiment of an end effector 125 in accordance with one or more aspects of the present disclosure. The end effector 125 may be implemented by systems that support automated nail shaping as described herein, including systems 100, 800, 900.

The end effector 125 may support contact-sensing operations of an automated nail shaping system. For example, the end effector 125 may include one or more sensors 1005 configured to detect whether the end effector 125 (e.g., the shaping tool 175) is in contact with the skin of an extremity 130 or the nail of an extremity 130. For example, a sensor 1005 may be an aspect of a contact sensing system configured to detect skin or nail contact based on capacitance and/or resistance measurements measured by the contact sensing system, for example as described elsewhere herein. In some example embodiments, the sensor 1005 may be a conductive structure that may serve as a capacitance sensor or a resistance sensor. In some example embodiments, the sensor 1005 may include a non-conductive structure (e.g., a nylon brush, a horsehair brush, among others) that is coated with a conductive material or include a non-conductive structure and a conductive structure (e.g., a wire wrapped at least partially around the non-conductive structure). In some example embodiments, the sensor 1005 may output the capacitance and/or resistance measurements to the toolpath planning system, the safety system, or both. In some example embodiments, the conductive structure of the sensor 1005 may be a conductive probe that is coupled with (e.g., wired to) sensing electronics configured to measure and output the capacitance and/or resistance measurements.

In the example embodiment of FIGS. 10A and 10B, the sensors 1005 are depicted as conductive brushes. Other conductive structures are possible. For example, the sensors 1005 may be any conductive protrusion, frame, or cover located near an end of the shaping tool 175 (e.g., between one to ten millimeters from the end of the shaping tool 175) such that contact measured by the sensors 1005 may approximate contact by the shaping tool 175. Alternatively, contact measured by the sensors 1005 may indicate whether and how close the shaping tool 175 is to touching the skin of an extremity (e.g., based on a known distance between the sensors 1005 and the shaping tool 175) such that the system may be able to prevent the shaping tool 175 from contacting the skin. In some example embodiments, the shaping tool 175 itself may be used as a contact sensor (e.g., as a conductive probe coupled with sensing electronics) in addition to the sensors 1005.

Additionally, or alternatively, the end effector 125 may support temperature measurement operations of an automated nail shaping system. For example, the end effector 125 may include one or more temperature sensors 1010. A temperature sensor 1010 may be used to measure a temperature of one or more components of the end effector 125 (e.g., as a proxy or indication of a temperature of the shaping tool 175, a temperature of the extremity 130, a temperature of a digit or nail in contact with the end effector 125). For example, the end effector 125 may include one or more temperature sensors 1010A connected to the sensors 1005. The temperature sensors 1010A may measure a temperature of the sensors 1005 and output the temperature measurement to the toolpath planning system, the safety system, or both. Additionally, or alternatively, the end effector may include a temperature sensor 1010B connected to the shaping tool 175 (e.g., a bearing 640 coupled with the shaping tool 175, a shaping tool holder 635, a shaft coupler 630). The temperature sensor 1010B may measure a temperature of the shaping tool 175 (e.g., the bearing 640, the shaping tool holder 635, the shaft coupler 630) and output the temperature measurement to the toolpath planning system, the safety system, or both. In some example embodiments, the temperature sensors 1010 may be contact-based temperature sensors, such as thermistors or thermocouples.

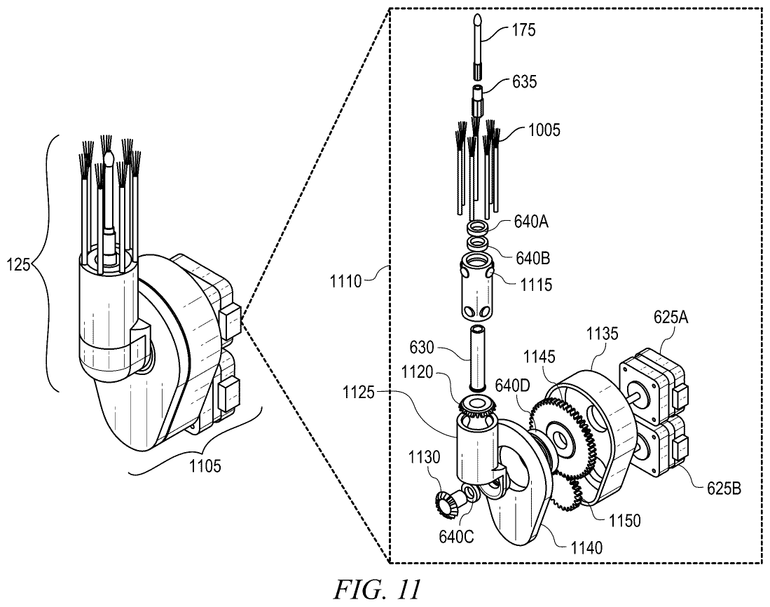

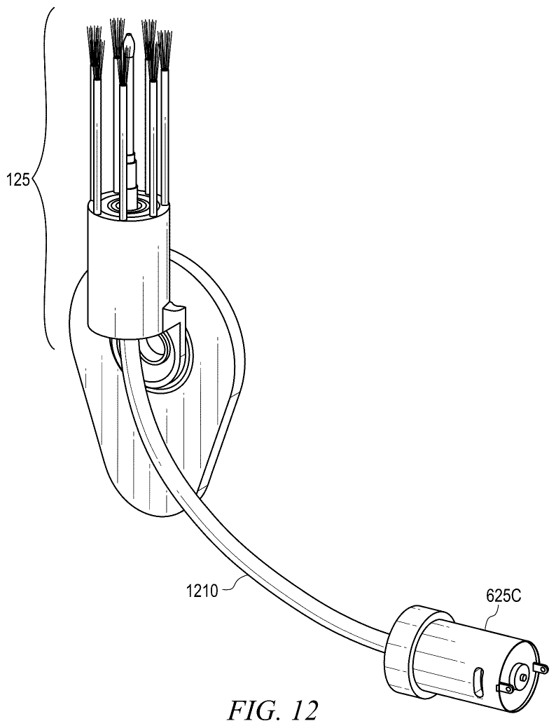

FIG. 11 depicts aspects of a system for nail shaping in accordance with one or more aspects of the present disclosure. For example, FIG. 11 depicts an end effector 125 that may be implemented by systems that support automated nail shaping as described herein, including systems 100, 800, 900. In some example embodiments, the end effector 125 may be coupled with one or more motors 625 that are outside of the end effector 125 itself. For example, the end effector 125 may be coupled with a motor system 1105 (e.g., which may be a part of a robotic arm 115) that connects a shaping tool 175 of the end effector 125 to the one or more motors 625 to control operation of the shaping tool 175.

Exploded view 1110 depicts components of the end effector 125 and the motor system 1105. The end effector 125 includes a shaping tool 175 connected to a shaping tool holder 635. The shaping tool holder 635 may be connected to a shaft coupler 630, which may be connected to one or more bearings 640 (e.g., bearings 640A, 640B) and rigidly connected to a gear 1120 (e.g., connected to reduce or prevent wobble). The shaft coupler 630 may be rotationally driven by the gear 1120. The gear 1120 may be housed in a housing 1115, which may be an example of an inner housing 610 described herein. The gear 1120 and the housing 1115 may be included in a housing 1125, which may be an example of an outer housing 605 described herein. The housing 1125 may include a gear 1130 (e.g., a bevel gear) and a bearing 640C. The motor system 1105 may include a housing 1135 and a housing cap 1140 that together include a bearing 640D, a gear 1145, and a gear 1150. The housing 1125 may be rigidly connected to the gear 1145 and may rotate relative to the housing 1135 and housing cap 1140. The end effector 125 may be connected to the motor system 1105 through the bearing 640D. The motor system 1105 may include a motor 625 connected to the gear 1130 and a motor 625B connected to the gear 1150.

In operation, the motor 625B may be configured to drive the gear 1150 which may drive the gear 1145. Driving the gear 1145 may rotate the housing 1125 (e.g., and by extension the shaping tool 175) relative to the housing 1135 and the housing cap 1140. For example, housing 1125 and the gears 1145 and 1150 may operate as a joint driven by the motor 625B to properly position the end effector 125. The motor 625A may be configured to drive the gear 1130 which may drive the gear 1120. Driving the gear 1120 may drive (e.g., rotate) the shaping tool 175 to shape the nail.

FIG. 12 depicts aspects of a system for nail shaping in accordance with one or more aspects of the present disclosure. For example, FIG. 12 depicts an end effector 125 that may be implemented by systems that support automated nail shaping as described herein, including systems 100, 800, 900. The end effector 125 may be coupled with a motor 625C that is outside of the end effector 125 itself. The end effector 125 may be coupled with the motor 625C via a cable 1210, which may be a flexible transmission cable capable of transferring the rotational drive of the motor 625C to the end effector 125 to control a shaping tool 175 of the end effector 125. In some example embodiments, the cable 1210 may include a spring-shaped cable housed in a flexible tube, where the spring-shaped cable may be capable of transferring the rotational drive.

FIGS. 13A, 13B, and 13C depict aspects of a system for nail shaping in accordance with one or more aspects of the present disclosure. For example, the aspects may be included in or implemented by a system that supports automated nail shaping described herein, including systems 100, 800, 900. FIGS. 13A and 13B depict bottom perspective and top perspective views of a portion of a nail shaping system that supports an extremity 130. FIG. 13C depicts an exploded view of FIG. 13A.

In some example embodiments, a placement platform 105 may be connected to a frame 110 via a frame connector 1305. The frame connector 1305 may include one or more coupling members configured to operably join the placement platform 105 to the frame 110. In some example embodiments, the frame connector 1305 may include an elongate tubular receiver configured to accept and secure frame member, and one or more coupling components (e.g., clevis-type) having spaced-apart arms with fastener openings for engaging a mating hinge or pin component. The frame connector 1305 may provide a modular interface that joins the placement platform 105 to the frame 110 in a fixed, pivotable, or extendable manner. In some example embodiments, one or more linear and/or rotational joints of the frame connector 1305 may be motorized. In some example embodiments, one or more of the joints of the frame connector 1305 may be passive. In some example embodiments, passive joints may be manually adjusted and/or locked in place by a user or operator. The example of frame connector 1305 may have six degrees of freedom (e.g., three translational degrees of freedom and three rotational degrees of freedom) between the extremity and the frame, however, other quantities of degrees of freedom are possible.

A digit-positioning structure 225 may be connected to the placement platform 105. In some example embodiments, the digit-positioning structure 225 may extend from the placement platform 105 and up between one or more digits of an extremity 130. In some example embodiments, the digit-positioning structure 225 may support vibrating one or more digits of the extremity 130 during operation of a robotic arm 115 and end effector 125. For example, the digit-positioning structure may include or be coupled with one or more vibration components 1315. The vibration components 1315 may vibrate the digit-positioning structure 225 such that it vibrates the digits. In some example embodiments, the digit-positioning structure 225 may extend to wrap around or otherwise contact another portion of the extremity 130 (e.g., one or more sides of a foot, one or more sides of a hand) and vibrating the digit-positioning structure 225 may vibrate the portion of the extremity 130. In some example embodiments, one or more vibration components 1315 may be coupled with the placement platform 105 and configured to vibrate the placement platform 105 (e.g., to vibrate the extremity 130). In some example embodiments, one or more vibration components 1315 may be coupled with the strap 220 and configured to vibrate the strap 220 (e.g., to vibrate the extremity 130). In some example embodiments, one or more vibration components 1315 may be coupled with another structure that contacts the extremity 130 and may be configured to vibrate the other structure.

In some example embodiments, ducts 1310 may be connected to the frame connector 1305. In some example embodiments, the ducts 1310 may be vacuum ducts 230 and/or blower ducts 235. In some example embodiments, the ducts 1310 may be located on either side of the extremity 130. Other locations and arrangements of the ducts 1310 are possible.

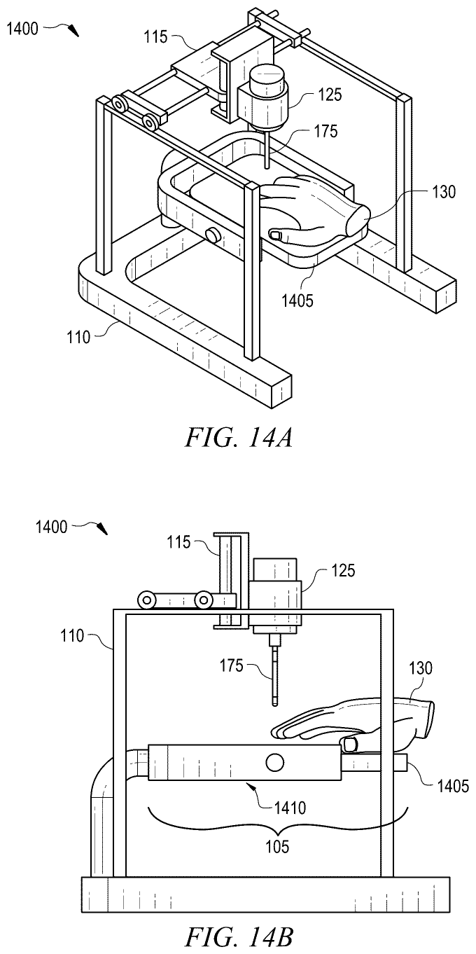

FIGS. 14A and 14B depict a system 1400 for nail shaping in accordance with one or more aspects of the present disclosure. The system 1400 supports automated nail shaping of one or more nails of a user. FIG. 14A depicts an upper-front perspective view of the system 1400. FIG. 14B depicts a side view of the system 1400.

The system 1400 may implement or be implemented by aspects of a nail shaping system described herein, including the systems 100, 800, 900. For example, the system 1400 may include a placement platform 105, a frame 110, a robotic arm 115, and an end effector 125, which may be examples of the corresponding components described herein. Additionally, the system 1400 may support automated nail shaping by generating a toolpath for the end effector 125 (e.g., based on a generated 3D scan) and operating the robotic arm 115 and end effector 125 in accordance with the generated toolpaths to perform a nail shaping process on nails of one or more extremities 130, as described herein.

In the example embodiment of system 1400, the robotic arm 115 may be a robotic arm having three translational degrees of freedom, such as a cartesian robotic arm. To achieve the desired nail shaping, the system 1400 may support additional degrees of freedom via the placement platform 105. For example, the placement platform 105 may include a movement stage 1405 having one or more rotational degrees of freedom. The placement platform 105 may also include a rotational component 1410 (e.g., a clevis component) to which the movement stage 1405 is connected such that the movement stage 1405 may rotate relative to the fixed frame 110. In some example embodiments, a control system of the system 1400 (e.g., the toolpath planning system) may generate a movement path for the movement stage 1405 based on the 3D scan (e.g., and other measurements such as force measurements, current measurements, and so on). The movement path and the toolpath may be generated so that the robotic arm 115 and movement stage 1405 move in conjunction to support nail shaping by the end effector 125. For example, while the robotic arm 115 translationally moves the end effector 125 according to the generated toolpath, the movement stage 1405 may rotate the extremity according to the movement path to achieve the desired nail shaping.

In some example embodiments, the degrees of freedom of the robotic arm 115 and the movement stage 1405 may be reversed (e.g., the robotic arm 115 may have one or more rotational degrees of freedom and the movement stage 1405 may have three translational degrees of freedom).

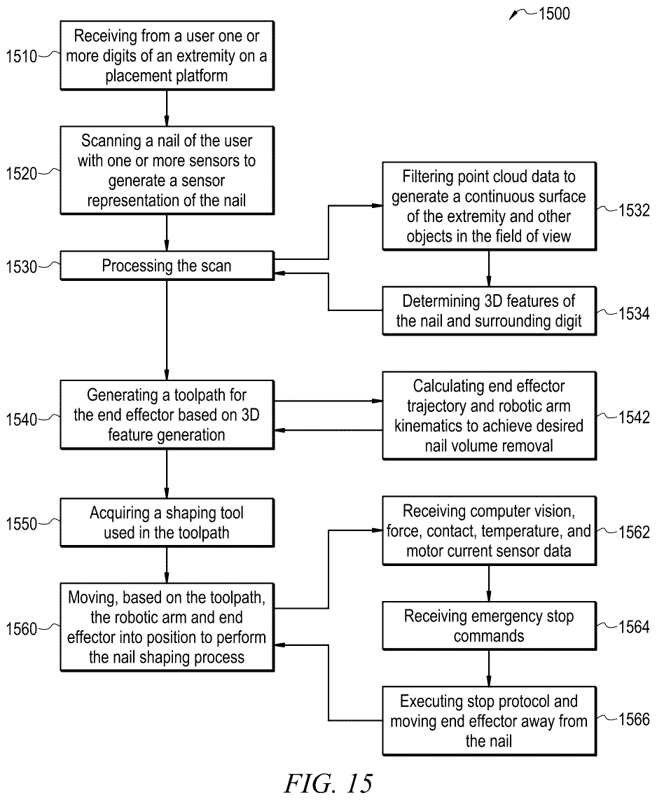

FIG. 15 depicts a flowchart illustrating a method 1500 in accordance with one or more aspects of the present disclosure. The operations of the method 1500 may be implemented by a system for nail shaping or its components as described herein. For example, the operations of the method 1500 may be performed by a system 100, 800, 900, or 1400 as described with reference to FIGS. 1-14. In some example embodiments, a system for nail shaping may execute a set of instructions to control the functional elements of the system to perform the described functions.

The method 1500 may be a method for nail shaping using a robotic arm and an end effector.

At 1510, the method may include receiving, from a user, one or more digits of an extremity on a placement platform of an automated nail shaping system.

At 1520, the method may include scanning a nail of the user with one or more sensors to generate a sensor representation (e.g., a 3D point cloud representation) of the nail. In some example embodiments, the scan may encompass additional objects within a field of view of the one or more sensors (e.g., one or more digits of the extremity, one or more robotic arms, one or more end effectors, and so on).

At 1530, the method may include processing the scan. In some example embodiments, processing the scan may include, at 1532, filtering point cloud data (e.g., the 3D point cloud representation) to generate a surface of the extremity and other objects in the field of view of the sensors. In some example embodiments, the surface of the extremity may be a coarse discretization of data points representing points (e.g., x-y-z positions) along the surface of the extremity. In some example embodiments, the surface of the extremity may be a fine discretization of data points, for example, upsampled from the coarse discretization. In some example embodiments, the surface of the extremity may be a continuous surface of the extremity that may be generated by interpolating from a discretized set of data points. In some example embodiments, processing the scan may include, at 1534, determining 3D features of the nail and surrounding digit (e.g., size, position, orientation, thickness, length, smoothness).

At 1540, the method may include generating a toolpath for an end effector of the system based on the 3D feature generation. For example, the toolpath may be generated such that the end effector performs a desired nail shaping process as it moves along the toolpath. In some example embodiments, the toolpath may be generated based on additional information acquired by the system (e.g., force measurements, current measurements, temperature measurements, capacitance measurements, resistances measurements, contact detection, and so on).

In some example embodiments, generating the toolpath may include, at 1542, calculating end effector trajectory and robotic arm kinematics to achieve the desired nail shaping (e.g., nail volume removal).

At 1550, the method may include acquiring a shaping tool used in the toolpath. For example, the toolpath may indicate a shaping tool for use in the nail shaping process. The method may include moving the robotic arm and end effector to insert the shaping tool into the end effector (e.g., from a tool rack).

At 1560, the method may include moving, based on the toolpath, the robotic arm and end effector into position to perform the nail shaping process. In some example embodiments, moving the robotic arm and end effector may include, at 1562, receiving computer vision, force, contact, temperature, motor current sensor data, or a combination thereof. In some example embodiments, the toolpath may be modified (e.g., updated, replaced) based on the data received. In some example embodiments, at 1564, the method may include receiving an emergency stop command, for example, based on a request from a safety system or based on a command from a controller usable by the user. In some example embodiments, at 1566, the method may include executing a stop protocol in response to receiving the emergency stop command. Executing the stop protocol may include moving the end effector away from the nail and cutting power to a motor operatively coupled to the shaping tool of the end effector.

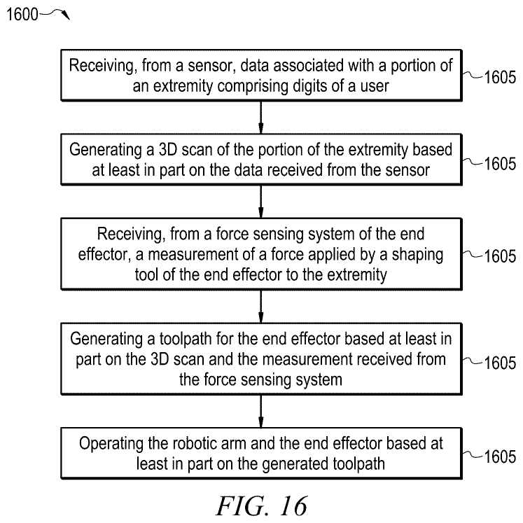

FIG. 16 depicts a flowchart illustrating a method 1600 in accordance with one or more aspects of the present disclosure. The operations of the method 1600 may be implemented by a system for nail shaping or its components as described herein. For example, the operations of the method 1500 may be performed by a system 100, 800, 900, or 1400 as described with reference to FIGS. 1-14. In some example embodiments, a system for nail shaping may execute a set of instructions to control the functional elements of the system to perform the described functions.

The method 1600 may be a method for nail shaping using a robotic arm and an end effector.

At 1605, the method may include receiving, from a sensor, data associated with a portion of an extremity that includes digits of a user.

At 1610, the method may include generating a 3D scan of the portion of the extremity based on the data received from the sensor.

At 1615, the method may include receiving, from a force sensing system of the end effector, a measurement of a force applied by a shaping tool of the end effector to the extremity.

At 1620, the method may include generating a toolpath for the end effector based on the 3D scan and the measurement received from the force sensing system.

At 1625, the method may include operating the robotic arm and the end effector based on the generated toolpath.

The following provides an overview of various exemplary aspects of the present disclosure:
Aspect 1. A system for nail shaping, the system comprising: a placement platform, the placement platform configured to receive at least one extremity comprising digits of a user; a frame; a robotic arm secured to the frame; a motor; an end effector operatively connected to a distal end of the robotic arm relative to the frame, the end effector comprising: a shaping tool operatively connected to the motor; and a force sensing system configured to measure a force applied by the shaping tool; a sensor positioned to face the at least one extremity; and a control system comprising one or more processors configured to: receive, from the sensor, data associated with a portion of the at least one extremity; generate a 3D scan of the portion of the at least one extremity based at least in part on data received from the sensor; receive, from the force sensing system, a measurement of the force applied by the shaping tool; generate a toolpath for the end effector based at least in part on the three-dimensional scan and the measurement received from the force sensing system; and operate the robotic arm and the end effector based at least in part on the generated toolpath.
Aspect 2. The system of aspect 1, wherein, to generate the toolpath for the end effector, the one or more processors are further configured to: determine a nail shaping process for at least one nail of a digit of the at least one extremity; and generate the toolpath such that the end effector performs the nail shaping process as the end effector moves along the toolpath.
Aspect 3. The system of any of aspects 1 through 2, wherein, to generate the toolpath for the end effector, the one or more processors are further configured to: determine one or more characteristics of the at least one extremity, the one or more characteristics comprising a position of the at least one extremity, an orientation of the at least one extremity, one or more characteristics of a digit of the at least one extremity, one or more characteristics of a nail of the at least one extremity, or a combination thereof; and generate the toolpath based at least in part on the one or more characteristics.
Aspect 4. The system of any of aspects 1 through 3, wherein, to operate the robotic arm and the end effector, the one or more processors are configured to: operate one or more motors operatively connected to the robotic arm to move the end effector along the toolpath; and operate the motor operatively connected to the shaping tool to control a speed and rotational direction of the shaping tool as the end effector is moved along the toolpath.
Aspect 5. The system of any of aspects 1 through 4, further comprising: a second robotic arm secured to the frame; a second motor; and a second end effector operatively connected to a distal end of the second robotic arm relative to the frame, the second end effector comprising: a second shaping tool operatively connected to the second motor; and a second force sensing system configured to measure a force applied by the second shaping tool, wherein the one or more processors are further configured to: receive, from the second force sensing system, a measurement of the force applied by the second shaping tool; generate a second toolpath for the second end effector based at least in part on the 3D scan and the measurement received from the second force sensing system; and operate, based at least in part on the second toolpath, the second robotic arm and the second end effector concurrent with the operation of the robotic arm and the end effector.
Aspect 6. The system of any of aspects 1 through 5, wherein the placement platform comprises a digit spacer configured to separate one or more digits of the at least one extremity.
Aspect 7. The system of any of aspects 1 through 6, wherein the placement platform comprises a digit holder configured to secure one or more digits of the at least one extremity in place.
Aspect 8. The system of any of aspects 1 through 7, wherein the placement platform comprises: a strap configured to cover a dorsum of the at least one extremity; and a data matrix connected to the strap, wherein the data received from the sensor includes data associated with the data matrix.
Aspect 9. The system of aspect 8, wherein the strap is configured to secure the at least one extremity in place.
Aspect 10. The system of any of aspects 1 through 9, further comprising a data matrix within a field of view of the sensor, wherein the data received from the sensor includes data associated with the data matrix.
Aspect 11. The system of any of aspects 1 through 10, wherein the force sensing system comprises a force sensitive resistor.
Aspect 12. The system of any of aspects 1 through 11, further comprising a temperature sensor comprising a thermal camera or a contact-based temperature sensor, the temperature sensor configured to: measure a temperature of the shaping tool, a temperature of the at least one extremity, a temperature of a digit of the at least one extremity, or a combination thereof; and output the measured temperature of the shaping tool, the measured temperature of the at least one extremity, the measured temperature of the digit, or the combination thereof, to the one or more processors, wherein the operation of the robotic arm and the end effector is based at least in part on the output.
Aspect 13. The system of any of aspects 1 through 12, wherein the one or more processors are further configured to halt operation of the robotic arm and the shaping tool in response to: a second measurement of the force applied by the shaping tool exceeding a force threshold; a current of the motor exceeding a current threshold; a speed of the motor exceeding a speed threshold; a temperature measurement exceeding a temperature threshold; a resistance measurement exceeding a resistance threshold; a capacitance measurement exceeding a capacitance threshold; second data from the sensor indicating that the shaping tool has contacted skin of the at least one extremity; or a combination thereof.
Aspect 14. The system of any of aspects 1 through 13, wherein the system further comprises a vibration system configured to vibrate one or more of digits of the at least one extremity during operation of the robotic arm and the end effector.
Aspect 15. The system of any of aspects 1 through 14, wherein the placement platform comprises a movement stage configured to move the placement platform, the one or more processors further configured to: generate a movement path for the movement stage based at least in part on the three-dimensional scan and the measurement received from the force sensing system.
Aspect 16. The system of any of aspects 1 through 15, wherein the system further comprises a vacuum system configured to draw airflow away from the at least one extremity.
Aspect 17. The system of any of aspects 1 through 16, wherein the system further comprises a blower system configured to direct airflow onto the at least one extremity.
Aspect 18. The system of any of aspects 1 through 17, wherein the shaping tool is a first shaping tool, the first shaping tool is removable, and the end effector is configured to receive a second shaping tool.
Aspect 19. The system of any of aspects 1 through 18, wherein the system further comprises a contact sensing system configured to detect whether the shaping tool contacts a nail of the at least one extremity or skin of the at least one extremity, the detection based at least in part on a capacitance measured by the contact sensing system, a current measured by the contact sensing system, or both.
Aspect 20. The system of any of aspects 1 through 19, wherein the system further comprises an input device configured to receive input from an operator and wherein the generation of the toolpath is further based on the input received from the operator.
Aspect 21. A method for nail shaping using a robotic arm and an end effector, comprising: receiving, from a sensor, data associated with a portion of an extremity comprising digits of a user; generating a 3D scan of the portion of the extremity based at least in part on the data received from the sensor; receiving, from a force sensing system of the end effector, a measurement of a force applied by a shaping tool of the end effector to the extremity; generating a toolpath for the end effector based at least in part on the 3D scan and the measurement received from the force sensing system; and operating the robotic arm and the end effector based at least in part on the generated toolpath.
Aspect 22. The method of aspect 21, wherein generating the toolpath comprises: determining a nail shaping process for a nail of a digit of the extremity; and generating the toolpath such that the end effector performs the nail shaping process as the end effector moves along the toolpath.
Aspect 23. The method of any of aspects 21 through 22, wherein generating the toolpath comprises: determining one or more characteristics of the extremity, the one or more characteristics comprising a position of the extremity, an orientation of the extremity, one or more characteristics of a digit of the extremity, one or more characteristics of a nail of the extremity, or a combination thereof; and generating the toolpath based at least in part on the one or more characteristics.
Aspect 24. The method of any of aspects 21 through 23, wherein operating the robotic arm and the end effector comprises: operating one or more motors operatively connected to the robotic arm to move the end effector along the toolpath; and operating a motor operatively connected to the shaping tool to control a speed and rotational direction of the shaping tool as the end effector is moved along the toolpath.
Aspect 25. The method of any of aspects 21 through 24, further comprising: receiving, from a second force sensing system of a second end effector, a measurement of a force applied by a second shaping tool of the second end effector to the extremity; generating a second toolpath for the second end effector based at least in part on the 3D scan and the measurement received from the second force sensing system; and operating, based at least in part on the second toolpath, a second robotic arm and the second end effector concurrent with operating the robotic arm and the end effector.
Aspect 26. The method of any of aspects 21 through 25, further comprising: separating one or more digits of the extremity using digit spacer of a placement platform configured to receive the extremity.
Aspect 27. The method of any of aspects 21 through 26, further comprising: securing one or more digits of the extremity in place using a digit holder of a placement platform configured to receive the extremity.
Aspect 28. The method of any of aspects 21 through 27, wherein the data received from the sensor comprises data associated with a data matrix connected to a strap configured to cover a dorsum of the extremity.
Aspect 29. The method of aspect 28, further comprising: securing the extremity in place using the strap.
Aspect 30. The method of any of aspects 21 through 29, wherein the data received from the sensor includes data associated with a data matrix within a field of view of the sensor.
Aspect 31. The method of any of aspects 21 through 30, wherein the force sensing system comprises a force sensitive resistor.
Aspect 32. The method of any of aspects 21 through 31, further comprising: measuring, using a temperature sensor comprising a thermal camera or a contact-based temperature sensor, a temperature of the shaping tool, a temperature of the extremity, a temperature of a digit of the extremity, or a combination thereof; and outputting the measured temperature of the shaping tool, the measured temperature of the extremity, the measured temperature of the digit, or the combination thereof, wherein operating the robotic arm and the end effector is based at least in part on the output.
Aspect 33. The method of any of aspects 21 through 32, further comprising halting operation of the robotic arm and the end effector in response to: a second measurement of the force applied by the shaping tool to the extremity exceeding a force threshold; a current of a motor operatively connected to the shaping tool exceeding a current threshold; a speed of the motor exceeding a speed threshold; a temperature measurement exceeding a temperature threshold; a resistance measurement exceeding a resistance threshold; a capacitance measurement exceeding a capacitance threshold; second data from the sensor indicating that the shaping tool has contacted skin of the extremity; or a combination thereof.
Aspect 34. The method of any of aspects 21 through 33, further comprising: vibrating one or more of digits of the extremity during operation of the robotic arm and the end effector.
Aspect 35. The method of any of aspects 21 through 34, further comprising: generating a movement path for a movement stage configured to move a placement platform that is configured to receive the extremity, the movement path generated based at least in part on the 3D scan and the measurement received from the force sensing system.
Aspect 36. The method of any of aspects 21 through 35, further comprising: drawing airflow away from the extremity using a vacuum system during operation of the robotic arm and end effector.
Aspect 37. The method of any of aspects 21 through 36, further comprising: directing airflow onto the extremity using a blower system during operation of the robotic arm and end effector.
Aspect 38. The method of any of aspects 21 through 37, wherein the shaping tool is a first shaping tool and the first shaping tool is removable, the method further comprising receiving a second shaping tool at the end effector.
Aspect 39. The method of any of aspects 21 through 38, further comprising: detecting, using a contact sensing system, whether the shaping tool contacts a nail of the extremity or skin of the extremity, the detection based at least in part on a capacitance measured by the contact sensing system, a current measured by the contact sensing system, or both.
Aspect 40. The method of any of aspects 21 through 39, further comprising: receiving input from an operator, wherein generating the toolpath is further based on the input received from the operator.
Aspect 41. A non-transitory computer-readable medium storing code for nail shaping using a robotic arm and an end effector, the code comprising instructions executable by one or more processors to: receive, from a sensor, data associated with a portion of an extremity of a user; generate a 3D scan of the portion of the extremity based at least in part on the data received from the sensor; receive, from a force sensing system of the end effector, a measurement of a force applied by a shaping tool of the end effector to the extremity; generate a toolpath for the end effector based at least in part on the 3D scan and the measurement received from the force sensing system; and operate the robotic arm and the end effector based at least in part on the generated toolpath.
Aspect 42. The non-transitory computer-readable medium of aspect 41, wherein, to generate the toolpath for the end effector, the code further comprising instructions executable by one or more processors to: determine a nail shaping process for a nail of a digit of the extremity; and generate the toolpath such that the end effector performs the nail shaping process as the end effector moves along the toolpath.
Aspect 43. The non-transitory computer-readable medium of any of aspects 41 through 42, wherein, to generate the toolpath for the end effector, the code further comprising instructions executable by one or more processors to: determine one or more characteristics of the extremity, the one or more characteristics comprising a position of the extremity, an orientation of the extremity, one or more characteristics of a digit of the extremity, one or more characteristics of a nail of the extremity, or a combination thereof; and generate the toolpath based at least in part on the one or more characteristics.
Aspect 44. The non-transitory computer-readable medium of any of aspects 41 through 43,wherein, to operate the robotic arm and the end effector, the code further comprising instructions executable by one or more processors to: operate one or more motors operatively connected to the robotic arm to move the end effector along the toolpath; and operate a motor operatively connected to the shaping tool to control a speed and rotational direction of the shaping tool as the end effector is moved along the toolpath.
Aspect 45. The non-transitory computer-readable medium of any of aspects 41 through 44, the code further comprising instructions executable by one or more processors to: receive, from a second force sensing system of a second end effector, a measurement of a force applied by a second shaping tool of the second end effector to the extremity; generate a second toolpath for the second end effector based at least in part on the 3D scan and the measurement received from the second force sensing system; and operate, based at least in part on the second toolpath, a second robotic arm and the second end effector concurrent with operating the robotic arm and the end effector.
Aspect 46. The non-transitory computer-readable medium of any of aspects 41 through 45, the code further comprising instructions executable by one or more processors to: separate one or more digits of the extremity using digit spacer of a placement platform configured to receive the extremity.
Aspect 47. The non-transitory computer-readable medium of any of aspects 41 through 46, the code further comprising instructions executable by one or more processors to: secure one or more digits of the extremity in place using a digit holder of a placement platform configured to receive the extremity.
Aspect 48. The non-transitory computer-readable medium of any of aspects 41 through 47, wherein the data received from the sensor comprises data associated with a data matrix connected to a strap configured to cover a dorsum of the extremity.
Aspect 49. The non-transitory computer-readable medium of aspect 48, the code further comprising instructions executable by one or more processors to: secure the extremity in place using the strap.
Aspect 50. The non-transitory computer-readable medium of any of aspects 41 through 49, wherein the data received from the sensor includes data associated with a data matrix within a field of view of the sensor.
Aspect 51. The non-transitory computer-readable medium of any of aspects 41 through 50, wherein the force sensing system comprises a force sensitive resistor.
Aspect 52. The non-transitory computer-readable medium of any of aspects 41 through 51, the code further comprising instructions executable by one or more processors to: measure, using a temperature sensor comprising a thermal camera or a contact-based temperature sensor, a temperature of the shaping tool, a temperature of the extremity, a temperature of a digit of the extremity, or a combination thereof; and outputting the measured temperature of the shaping tool, the measured temperature of the extremity, the measured temperature of the digit, or the combination thereof, wherein operation of the robotic arm and the end effector is based at least in part on the output.
Aspect 53. The non-transitory computer-readable medium of any of aspects 41 through 52, the code further comprising instructions executable by one or more processors to: halt operation of the robotic arm and the end effector in response to: a second measurement of the force applied by the shaping tool to the extremity exceeding a force threshold; a current of a motor operatively connected to the shaping tool exceeding a current threshold; a speed of the motor exceeding a speed threshold; a temperature measurement exceeding a temperature threshold; a resistance measurement exceeding a resistance threshold; a capacitance measurement exceeding a capacitance threshold; second data from the sensor indicating that the shaping tool has contacted skin of the extremity; or a combination thereof.
Aspect 54. The non-transitory computer-readable medium of any of aspects 41 through 53, the code further comprising instructions executable by one or more processors to: vibrate one or more of digits of the extremity during operation of the robotic arm and the end effector.
Aspect 55. The non-transitory computer-readable medium of any of aspects 41 through 54, the code further comprising instructions executable by one or more processors to: generate a movement path for a movement stage configured to move a placement platform that is configured to receive the extremity, the movement path generated based at least in part on the 3D scan and the measurement received from the force sensing system.
Aspect 56. The non-transitory computer-readable medium of any of aspects 41 through 55, the code further comprising instructions executable by one or more processors to: draw airflow away from the extremity using a vacuum system during operation of the robotic arm and end effector.
Aspect 57. The non-transitory computer-readable medium of any of aspects 41 through 56, the code further comprising instructions executable by one or more processors to: direct airflow onto the extremity using a blower system during operation of the robotic arm and end effector.
Aspect 58. The non-transitory computer-readable medium of any of aspects 41 through 57, wherein the shaping tool is a first shaping tool and the first shaping tool is removable, the code further comprising instructions executable by one or more processors to receive a second shaping tool at the end effector.
Aspect 59. The non-transitory computer-readable medium of any of aspects 41 through 58, the code further comprising instructions executable by one or more processors to: detect, using a contact sensing system, whether the shaping tool contacts a nail of the extremity or skin of the extremity, the detection based at least in part on a capacitance measured by the contact sensing system, a current measured by the contact sensing system, or both.
Aspect 60. The non-transitory computer-readable medium of any of aspects 41 through 59, the code further comprising instructions executable by one or more processors to: receive input from an operator, wherein generation of the toolpath is further based on the input received from the operator.

The various illustrative blocks and components described in connection with the disclosure herein may be implemented or performed with a general-purpose processor, a digital signal processor (DSP), an application-specific integrated circuit (ASIC), a central processing unit (CPU), a graphics processing unit (GPU), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the term “and/or” used herein is intended to signify and include any or all possible combinations of one or more items listed in the associated list.

It shall be understood that although the terms “first,” “second,” “third,” etc. may be used herein to describe various information, the information should not be limited by these terms. These terms are only used to distinguish one category of information from another. For example, without departing from the scope of the present disclosure, the first information may be termed as second information, and similarly, the second information may also be termed as first information.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and second condition or action may at least partially occur as a result of the previous condition or action occurring (whether directly after or after one or more other intermediate conditions or actions occurring after the first condition or action).

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “comprising” and any form of comprising, such as “comprise” and “comprises,” “having” and any form of having, such as “has” and “have,” “including” and any form of including, such as “includes” and “include,” or “containing” and any form of containing, such as “contains” and “contain,” are inclusive and open-ended and do not exclude additional, unrecited elements or method steps.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system for nail shaping, the system comprising:
a placement platform, the placement platform configured to receive at least one extremity comprising digits of a user;
a frame;
a robotic arm secured to the frame;
a motor;
an end effector operatively connected to a distal end of the robotic arm relative to the frame, the end effector comprising:
a shaping tool operatively connected to the motor; and
a force sensing system configured to measure a force applied by the shaping tool;
a sensor positioned to face the at least one extremity; and
a control system comprising one or more processors configured to:
receive, from the sensor, data associated with a portion of the at least one extremity;
generate a three-dimensional scan of the portion of the at least one extremity based at least in part on data received from the sensor;
receive, from the force sensing system, a measurement of the force applied by the shaping tool;
generate a toolpath for the end effector based at least in part on the three-dimensional scan and the measurement received from the force sensing system; and
operate the robotic arm and the end effector based at least in part on the generated toolpath.

2. The system of claim 1, wherein, to generate the toolpath for the end effector, the one or more processors are further configured to:
determine a nail shaping process for at least one nail of a digit of the at least one extremity; and
generate the toolpath such that the end effector performs the nail shaping process as the end effector moves along the toolpath.

3. The system of claim 1, wherein, to generate the toolpath for the end effector, the one or more processors are further configured to:
determine one or more characteristics of the at least one extremity, the one or more characteristics comprising a position of the at least one extremity, an orientation of the at least one extremity, one or more characteristics of a digit of the at least one extremity, one or more characteristics of a nail of the at least one extremity, or a combination thereof; and
generate the toolpath based at least in part on the one or more characteristics.

4. The system of claim 1, wherein, to operate the robotic arm and the end effector, the one or more processors are configured to:
operate one or more motors operatively connected to the robotic arm to move the end effector along the toolpath; and
operate the motor operatively connected to the shaping tool to control a speed and rotational direction of the shaping tool as the end effector is moved along the toolpath.

5. The system of claim 1, further comprising:
a second robotic arm secured to the frame;
a second motor; and
a second end effector operatively connected to a distal end of the second robotic arm relative to the frame, the second end effector comprising:
a second shaping tool operatively connected to the second motor; and
a second force sensing system configured to measure a force applied by the second shaping tool,
wherein the one or more processors are further configured to:
receive, from the second force sensing system, a measurement of the force applied by the second shaping tool;
generate a second toolpath for the second end effector based at least in part on the three-dimensional scan and the measurement received from the second force sensing system; and
operate, based at least in part on the second toolpath, the second robotic arm and the second end effector concurrent with the operation of the robotic arm and the end effector.

6. The system of claim 1, wherein the placement platform comprises a digit spacer configured to separate one or more digits of the at least one extremity.

7. The system of claim 1, wherein the placement platform comprises a digit holder configured to secure one or more digits of the at least one extremity in place.

8. The system of claim 1, wherein the placement platform comprises:
a strap configured to cover a dorsum of the at least one extremity; and
a data matrix connected to the strap, wherein the data received from the sensor includes data associated with the data matrix.

9. The system of claim 8, wherein the strap is configured to secure the at least one extremity in place.

10. The system of claim 1, further comprising a data matrix within a field of view of the sensor, wherein the data received from the sensor includes data associated with the data matrix.

11. The system of claim 1, wherein the force sensing system comprises a force sensitive resistor.

12. The system of claim 1, further comprising a temperature sensor comprising a thermal camera or a contact-based temperature sensor, the temperature sensor configured to:
measure a temperature of the shaping tool, a temperature of the at least one extremity, a temperature of a digit of the at least one extremity, or a combination thereof; and
output the measured temperature of the shaping tool, the measured temperature of the at least one extremity, the measured temperature of the digit, or the combination thereof, to the one or more processors, wherein the operation of the robotic arm and the end effector is based at least in part on the output.

13. The system of claim 1, wherein the one or more processors are further configured to halt operation of the robotic arm and the shaping tool in response to:
a second measurement of the force applied by the shaping tool exceeding a force threshold;
a current of the motor exceeding a current threshold;
a speed of the motor exceeding a speed threshold;
a temperature measurement exceeding a temperature threshold;
a resistance measurement exceeding a resistance threshold;
a capacitance measurement exceeding a capacitance threshold;
second data from the sensor indicating that the shaping tool has contacted skin of the at least one extremity; or
a combination thereof.

14. The system of claim 1, wherein the system further comprises a vibration system configured to vibrate one or more of digits of the at least one extremity during operation of the robotic arm and the end effector.

15. The system of claim 1, wherein the placement platform comprises a movement stage configured to move the placement platform, the one or more processors further configured to:
generate a movement path for the movement stage based at least in part on the three-dimensional scan and the measurement received from the force sensing system.

16. The system of claim 1, wherein the system further comprises a vacuum system configured to draw airflow away from the at least one extremity.

17. The system of claim 1, wherein the system further comprises a blower system configured to direct airflow onto the at least one extremity.

18. The system of claim 1, wherein the shaping tool is a first shaping tool, the first shaping tool is removable, and the end effector is configured to receive a second shaping tool.

19. The system of claim 1, wherein the system further comprises a contact sensing system configured to detect whether the shaping tool contacts a nail of the at least one extremity or skin of the at least one extremity, the detection based at least in part on a capacitance measured by the contact sensing system, a current measured by the contact sensing system, or both.

20. The system of claim 1, wherein the system further comprises an input device configured to receive input from an operator and wherein the generation of the toolpath is further based on the input received from the operator.

21. A method for nail shaping using a robotic arm and an end effector, comprising:
receiving, from a sensor, data associated with a portion of an extremity comprising digits of a user;
generating a three-dimensional scan of the portion of the extremity based at least in part on the data received from the sensor;
receiving, from a force sensing system of the end effector, a measurement of a force applied by a shaping tool of the end effector to the extremity;
generating a toolpath for the end effector based at least in part on the three-dimensional scan and the measurement received from the force sensing system; and
operating the robotic arm and the end effector based at least in part on the generated toolpath.

22. The method of claim 21, wherein generating the toolpath comprises:
determining a nail shaping process for a nail of a digit of the extremity; and
generating the toolpath such that the end effector performs the nail shaping process as the end effector moves along the toolpath.

23. The method of claim 21, wherein generating the toolpath comprises:
determining one or more characteristics of the extremity, the one or more characteristics comprising a position of the extremity, an orientation of the extremity, one or more characteristics of a digit of the extremity, one or more characteristics of a nail of the extremity, or a combination thereof; and
generating the toolpath based at least in part on the one or more characteristics.

24. The method of claim 21, wherein operating the robotic arm and the end effector comprises:
operating one or more motors operatively connected to the robotic arm to move the end effector along the toolpath; and
operating a motor operatively connected to the shaping tool to control a speed and rotational direction of the shaping tool as the end effector is moved along the toolpath.

25. The method of claim 21, further comprising halting operation of the robotic arm and the end effector in response to:
a second measurement of the force applied by the shaping tool to the extremity exceeding a force threshold;
a current of a motor operatively connected to the shaping tool exceeding a current threshold;
a speed of the motor exceeding a speed threshold;
a temperature measurement exceeding a temperature threshold;
a resistance measurement exceeding a resistance threshold;
a capacitance measurement exceeding a capacitance threshold;
second data from the sensor indicating that the shaping tool has contacted skin of the extremity;
or a combination thereof.

26. The method of claim 21, wherein the data received from the sensor comprises data associated with a data matrix connected to a strap configured to cover a dorsum of the extremity.

27. A non-transitory computer-readable medium storing code for nail shaping using a robotic arm and an end effector, the code comprising instructions executable by one or more processors to:
receive, from a sensor, data associated with a portion of an extremity of a user;
generate a three-dimensional scan of the portion of the extremity based at least in part on the data received from the sensor;
receive, from a force sensing system of the end effector, a measurement of a force applied by a shaping tool of the end effector to the extremity;
generate a toolpath for the end effector based at least in part on the three-dimensional scan and the measurement received from the force sensing system; and
operate the robotic arm and the end effector based at least in part on the generated toolpath.
